(19) United States
(12) Patent Application Publication
(10) Pub. No.: US 2016/0373346 A1
(43) Pub. Date: Dec. 22, 2016

(54) DATA PROCESSING SYSTEM, DATA PROCESSING METHOD AND COMPUTER READABLE MEDIUM

(71) Applicant: FUJITSU LIMITED, Kawasaki-shi (JP)

(72) Inventor: Masaki HIROTA, Kawasaki (JP)

(73) Assignee: FUJITSU LIMITED, Kawasaki-shi (JP)

(21) Appl. No.: 15/160,123

(22) Filed: May 20, 2016

(30) Foreign Application Priority Data
Jun. 19, 2015 (JP) 2015-123428

(51) Int. Cl. H04L 12/721; H04L 29/12; H04L 29/06; H04L 12/741

(52) U.S. Cl. CPC H04L 45/38; H04L 45/74; H04L 61/6022; H04L 69/22

(57) ABSTRACT

A data processing system includes: a plurality of processing units configured to execute processing for a plurality of packets; and a processor configured to transmit the plurality of packets to the plurality of processing units. The processor is configured to calculate processing cost total value for each of the plurality of processing units by adding the value of the processing cost of each of the transmitted packets each time the packet is transmitted to any one of the plurality of processing units, based on processing cost information indicating a value of a processing cost of each of the plurality of packets, and subtracting the value of the processing cost of each of the plurality of received packets, select a transmission destination of a first packet, by comparing the processing cost total values of the plurality of processing units, and transmit the first packet to the selected processing unit.

### CROSS-REFERENCE TO RELATED APPLICATION

This application is based upon and claims the benefit of priority of the prior Japanese Patent Application No. 2015-123428, filed on Jun. 19, 2015, the entire contents of which are incorporated herein by reference.

### FIELD

The embodiments discussed herein are related to a data processing system, a data processing method, and a computer readable medium.

### BACKGROUND

A packet transmitted within a network is distributed to a destination node through a packet relay device such as a layer 2 switch, a layer 3 switch, or a router. The layer 2 switch transmits a packet to a certain port, with reference to a media access control (MAC) address included in header information of the packet. In addition, the layer 3 switch or the router transmits a packet to a subsequent relay device, with reference to an Internet Protocol (IP) address included in the header information of the packet. Each of the relay devices extracts desired information from the header information of the received packet, and executes processing such selection of an output port and rewriting of the header information. For example, in a router, in order to route a packet appropriately, for example, pieces of processing such as deletion of a MAC address, filtering of a packet, extraction of an IP address, addition of a multi-protocol label switching identification (MPLSID), and addition of an MAC address are executed. When such pieces of processing are executed by causing a central processing unit (CPU) in the relay device to execute a computer program, by using a dedicated circuit such as an application specific integrated circuit (ASIC) provided in the relay device, or by using a programmable device such as a field programmable gate array (FPGA).

As a technology in a related art of a packet relay device, a technology is known in which a relay device includes a plurality of processor elements, and the plurality of processor elements process a plurality of packets that has been received from a plurality of sources in parallel (for instance, see Japanese Laid-open Patent Publication No. 2000-358066). FIG. 1 illustrates a relay device including an input unit 1, a switch mechanism 2, and an output unit 3 in a technology in the related art. The input unit 1 includes a processor array module 5 including a plurality of processing elements 4. In the technology in the related art, some methods are discussed for an algorithm to distribute packets to the plurality of processing elements 4 when relay processing is executed by the plurality of processing element 4 operated in parallel. For example, a method is discussed in which processing of a packet that has been transmitted from a specific source is allocated to a specific processing element 4 included in the processor array module 5. In this case, even when a processing load of a further processing element 4 is lower than a processing load of the specific processing element 4, it is difficult to allocate the packet that has been transmitted from the certain source to the further processing element 4. As a result, there occurs a case in which the processing capacity of the whole processor array module 5 is not fully utilized.

In addition, as a further method, a method is discussed in which the processing elements 4 included in the processor array module 5 are shared for a plurality of packets that has been transmitted from a plurality of sources. In this case, at a time of determination of a processing element 4 caused to process a packet, a processing element 4 is selected with reference to the gravity of the processing load of each of the processing elements 4. Therefore, the processing efficiency of the whole processor array module 5 may be improved. However, in such a method, there is a case in which the order of a plurality of packets that has been transmitted from a certain source is changed in the relay device and the packets are transferred. For example, when the relay device allocates a first packet that has been received from a certain source to a first processing element 4, and allocates a second packet that has been received from the certain source after the first packet to a second processing element 4 having a processing load smaller than the processing load of the first processing element 4 at that time point, it is probable that the processing of the second packet in the second processing element 4 is completed earlier than the processing of the first packet in the first processing element 4. Therefore, a change in the order of the plurality of packets that have been transmitted from the certain source occurs in the relay processing.

In order to avoid such a change in the packet order in the parallel processing using the plurality of processing elements, a technology described below is discussed in Japanese Laid-open Patent Publication No. 2000-358066.

FIG. 2 is a diagram illustrating a relationship between a processing element 4 and an input control device 6 that receives a packet and allocates the packet to the processing element 4 in the technology in the related art. The processing element 4 notifies the input control device 6 whether or not the processing element 4 is processing a packet from a certain source, using a mask reset line 8. When a preceding packet from the certain source is currently being processed in a certain processing element 4, the input control device 6 allocates a further packet that has been received from the certain source to the processing element 4 that is processing the preceding packet. In addition, when the preceding packet from the certain source is not currently being processed in the processing element 4, the input control device 6 may allocate a further packet that has been received from the certain source to a further processing element 4. As a result, packet relay processing may be executed using a plurality of processing elements 4 efficiently without a change in the order of a plurality of packets that has been input from an identical source to a relay device.

In addition, in the technology in the related art, selection of a processing element 4 from the plurality of processing elements 4 is discussed as follows in a case in which a processing element 4 that is responsible for processing of a plurality of packets that has been received from an identical source is changed from a certain processing element 4 to a further processing element 4. Each of the processing elements 4 notifies the input control device 6 of backlog information of packets that have been allocated to the processing element 4 (backlog processing amount), using a backlog update line 9 illustrated in FIG. 2. The input control device 6 compares pieces of backlog information that have been received from all of the processing elements 4, and selects a processing element 4 having the smallest backlog value. In addition, for a packet that has been received from a certain source, when a preceding packet from the certain source is not processed in any of the processing elements 4, the input control device 6 allocates the received packet to the processing element 4 having the smallest backlog value. As a result, relay processing of a plurality of packets that has been received from a certain source may be executed using a processing element 4 having the smallest backlog from among the plurality of processing elements 4 without changing the order of the packets.

### SUMMARY

According to an aspect of the invention, a data processing system includes: a plurality of processing units configured to execute processing for a plurality of packets; and a processor coupled to the plurality of processing units and configured to transmit the plurality of packets to the plurality of processing units, and receive, from the plurality of processing units, a plurality of packets including processing results processed by the plurality of processing units. The plurality of processing units are configured to execute processing for the plurality of packets transmitted from the processor based on processing content information used to identify a content of the processing to be executed for each of the plurality of packets. The processor is configured to store, in a memory, processing cost information indicating a value of a processing cost of each of the plurality of packets, each of the processing cost information indicating a weight of a load to execute the processing for the corresponding packet and being defined in accordance with the content of the processing identified by the processing content information, calculate a first processing cost total value for each of the plurality of processing units by adding the value of the processing cost of each of the plurality of transmitted packets, based on the processing cost information stored in the memory each time the packet is transmitted to any one of the plurality of processing units, and subtracting the value of the processing cost of each of the plurality of received packets, each time the packet is received from any one of the plurality of processing units, select, from the plurality of processing units, a processing unit that is a transmission destination of a first packet, by comparing the first processing cost total values of the plurality of processing units with each other, and transmit the first packet to the selected processing unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a relay device in a related art;

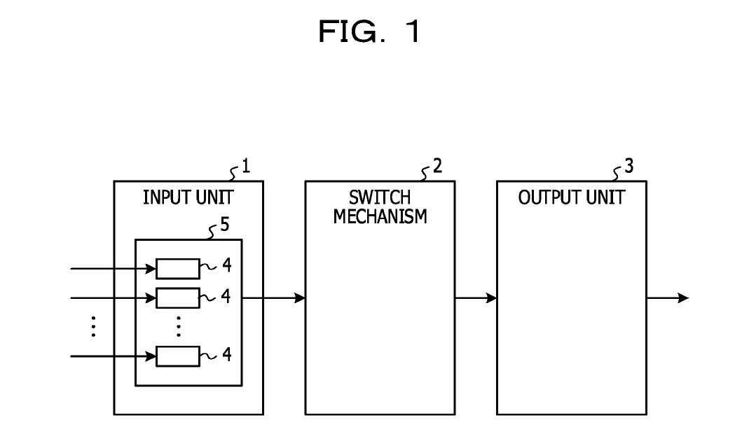

FIG. 2 is a diagram illustrating an example of processing of the relay device in the related art;

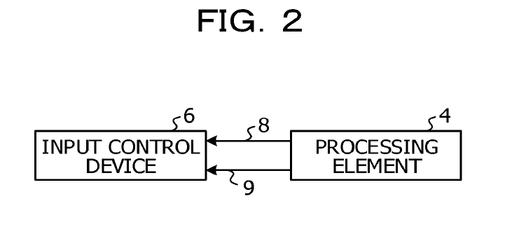

FIG. 3 is diagram illustrating a configuration example of a network according to a first embodiment;

FIG. 4 is diagram illustrating a hardware configuration example of a relay device according to the first embodiment;

FIG. 5 is a diagram illustrating a function block of the relay device according to the first embodiment;

FIG. 6 is a diagram illustrating a data configuration example of a packet according to the first embodiment;

FIG. 7 is a diagram illustrating an example of a processing content of relay processing according to the first embodiment;

FIG. 8 is an example of a flowchart illustrating relay processing according to the first embodiment;

FIG. 9 is a further example of a flowchart illustrating the relay processing according to the first embodiment;

FIG. 10 is a diagram illustrating an example of a processing cost table according to the first embodiment;

FIG. 11 is a diagram illustrating an example of a flow ID table according to the first embodiment;

FIG. 12 is a diagram illustrating a count method of processing costs of packets that are being processed in the first embodiment;

FIG. 13 is a diagram illustrating a function block of a processor according to the first embodiment;

FIG. 14 is a diagram illustrating an example of an allocation processing unit table according to the first embodiment;

FIG. 15 is a flowchart illustrating the relay processing according to the first embodiment;

FIG. 16 is a diagram illustrating a function block of a processor according to a second embodiment;

FIG. 17 is a flowchart illustrating relay processing according to the second embodiment;

FIG. 18 is a diagram illustrating a function block of a processor according to a third embodiment;

FIG. 19 is a flowchart illustrating relay processing according to the third embodiment;

FIG. 20 is a diagram illustrating a function block of a processor according to a fourth embodiment;

FIG. 21 is a flowchart illustrating relay processing according to the fourth embodiment;

FIG. 22 is a diagram illustrating a function block of a processor according to a fifth embodiment;

FIG. 23 is a flowchart illustrating relay processing according to the fifth embodiment;

FIG. 24 is a diagram illustrating a function block of a processor according to a sixth embodiment;

FIG. 25 is a flowchart illustrating relay processing according to the sixth embodiment; and

FIG. 26 is a diagram illustrating a function block of a processor according to a seventh embodiment.

### DESCRIPTION OF EMBODIMENTS

In the technology in the related art, each of the processing elements 4 stores the number of backlogs that reflects the number of packets that have been received from a certain source, which are being processed in the processing element 4. For example, in the technology in the related art, when the processing element 4 receives a packet from the certain source, a backlog register in the processing element 4 increases the number of backlogs, and when the processing of the packet that has been received from the certain source in the processing element 4 is completed, the backlog register decreases the number of backlogs.

However, in the technology in the related art, a specific technical measure that calculates the number of backlogs increased when each of the processing elements 4 has received a packet is not discussed. In addition, in the technology in the related art, a specific technical measure that calculates the number of backlogs decreased when each of the processing elements 4 has completed processing of a packet is also not discussed. A processing content for a packet may be changed depending on a packet, so that it is difficult to estimate the number of backlogs of each of the processing elements 4 simply based on the number of packets when the plurality of packets is processed.

In an embodiment, a processing unit that is a transmission destination of a first packet may be selected appropriately by comparing first processing cost total values of a plurality of processing units.

### First Embodiment

In the embodiment, a value of a processing cost of a packet is obtained for each flow of received packets, and values of processing costs of packets that are being processed in a relay device are combined to calculate a processing cost total value, and the packets are allocated to a plurality of processing units based on the processing cost total values.

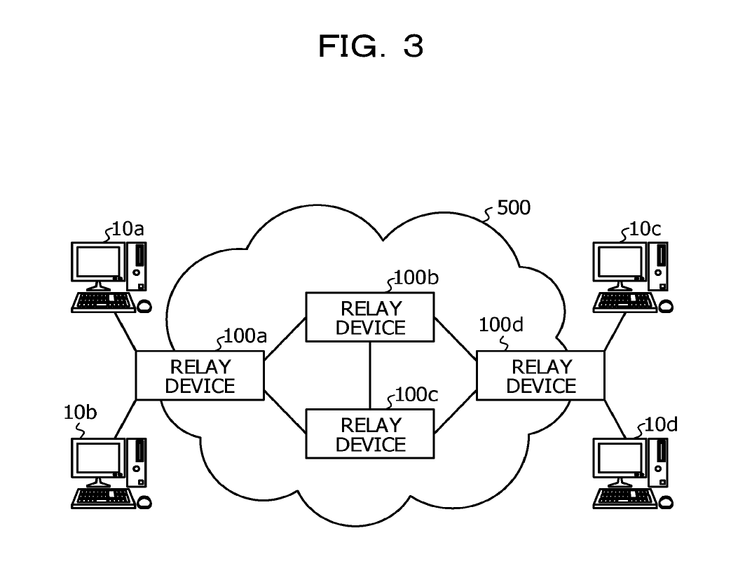

FIG. 3 is a diagram illustrating a configuration example of a network including a relay device according to the embodiments. Here, an example is described in which a plurality of information processing devices 10a, 10b, 10c, and 10d perform transmission and reception of packets through a network 500 that includes relay devices 100a, 100b, 100c, and 100d. Each of the information processing devices 10a, 10b, 10c, and 10d is, for example, a personal computer (PC), a server, or the like. In the following description, the configuration and the function of the relay device 100a are described, and the configuration and the function described herein may be applied to the further relay devices 100b, 100c, and 100d. The relay device 100a functions, for example, as a layer 2 switch for a packet that has been received from the information processing device 10a, and may transfer the packet to the information processing device 10b coupled to the relay device 100a. In addition, the relay device 100a functions, for example, as a layer 3 switch or a router for a packet that has been received from the information processing device 10a, and may transfer the packet to the information processing device 10c or 10d through the network 500. In addition, the relay device 100a functions, for example, as a layer 2 switch for a packet that has been received from the information processing device 10c through the network 500, and may transfer the packet to the information processing device 10a or 10b.

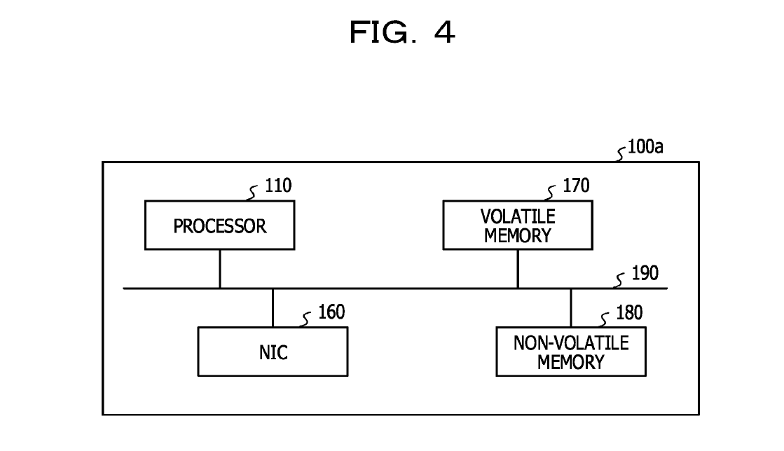

FIG. 4 is a diagram illustrating an example of a hardware configuration of the relay device 100a. The relay device 100a includes a processor 110, a network interface card (NIC) 160, a volatile memory 170, a non-volatile memory 180, and a bus 190. The NIC 160 receives a packet from the information processing device 10a, the information processing device 10b, or the network 500. In addition, the NIC 160 transfers a packet to the information processing device 10a, the information processing device 10b, and the further relay device 100b included in the network 500, or the like. The processor 110 executes processing such as deletion, addition, modification, or the like for a part of header information of the packet that has been received in the NIC 160, and performs determination of a transfer destination of the packet. In addition, in the embodiment, the processor 110 may function as a load distribution unit 120 described later. The processor 110 is an electronic circuit component such as a CPU, a micro control unit (MCU), a micro-processing unit (MPU), a digital signal processor (DSP), or a FPGA.

The volatile memory 170 stores data used when the processor 110 executes certain processing and a result of the processing. In addition, a computer program to be executed by the processor 110 is loaded from the non-volatile memory 180 to the volatile memory 170. The volatile memory 170 is an electronic circuit component such as a dynamic random access memory (DRAM) or a static random access memory (SRAM).

The non-volatile memory 180 stores the computer program and the like to be executed by the processor 110. The non-volatile memory 180 is an electronic circuit component such as a mask read only memory (Mask ROM), a programmable ROM (PROM), or a flash memory.

The bus 190 connects the processor 110, the NIC 160, the volatile memory 170, the non-volatile memory 180, and the like to each other, and functions as a path for transmission of data between the units.

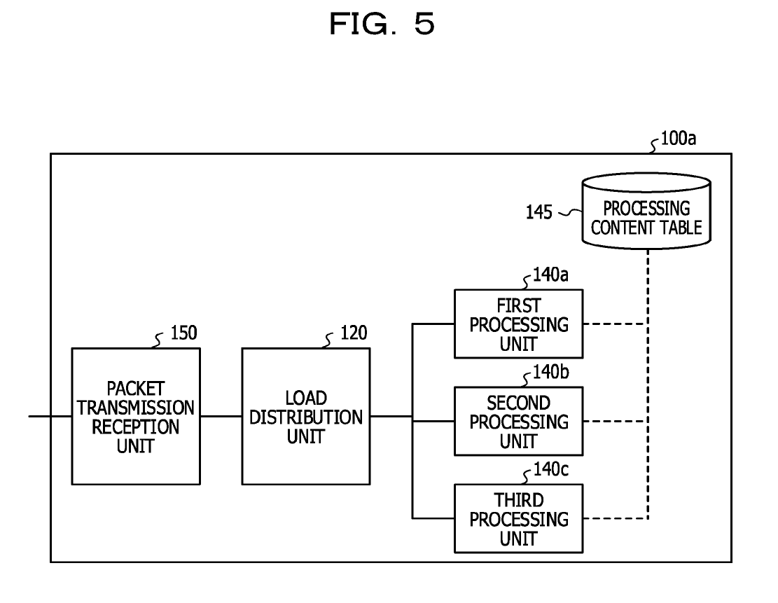

FIG. 5 is a diagram illustrating a function block of the relay device 100a. The relay device 100a functions as a packet transmission/reception unit 150, the load distribution unit 120, a first processing unit 140a, a second processing unit 140b, and a third processing unit 140c. In the embodiment, as a plurality of processing units, the three processing units 140a, 140b, and 140c are illustrated, but any number of processing units, which is two or more, may be provided. In the following description, when there is no intention that any one of the first processing unit 140a, the second processing unit 140b, and the third processing unit 140c is specified, the processing unit is simply referred to as “processing unit 140”. In addition, the relay device 100a stores a processing content table 145 in which a content of processing executed by each of the processing units 140 is defined. The packet transmission/reception unit 150 performs transmission and reception of a packet. The load distribution unit 120 determines a processing unit 140 caused to process a received plurality of packets, from among the plurality of processing units 140. In addition, the load distribution unit 120 selects a processing unit 140 so that the order of packets is not changed in the relay processing in the relay device 100a for a plurality of packets that belong to an identical flow such as a plurality of packets transmitted to an identical destination from an identical transmission source or a plurality of packets having an identical virtual local area network identification (VLAN ID). In addition, the load distribution unit 120 selects a processing unit 140 based on the processing loads of the plurality of processing units 140, and allocates a packet to the selected processing unit 140.

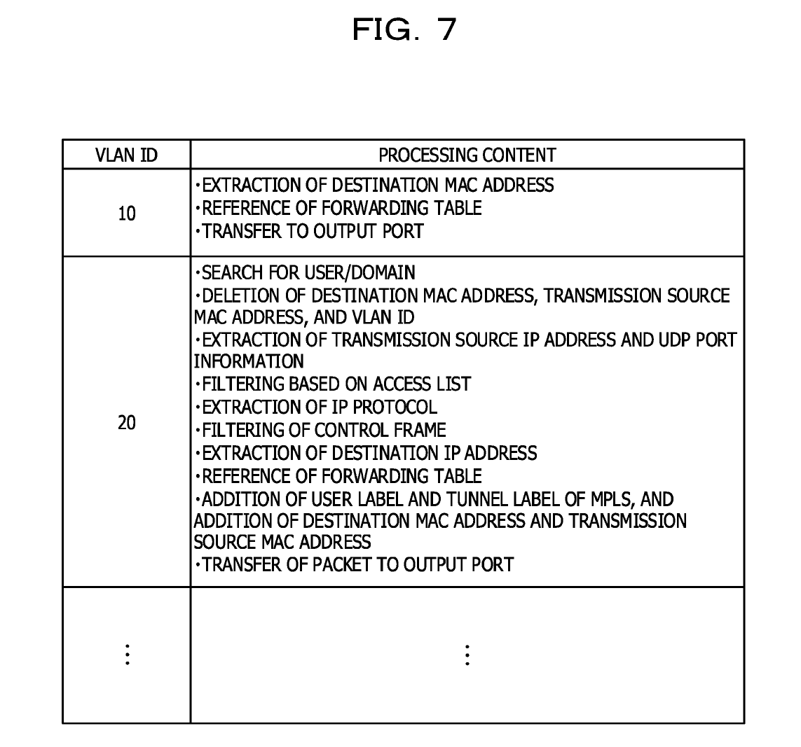

For the respective packets that have been allocated by the load distribution unit 120, each of the plurality of processing units 140 executes processing such as rewriting of a header as appropriate so that the packet is transmitted to a certain destination, in accordance with the content of the processing content table 145. The processing content table 145 is described in detail later with reference to FIGS. 7 to 9. The packet for which the processing has been completed by the processing unit 140 is transmitted through the packet transmission/reception unit 150.

In FIG. 5, the load distribution unit 120 is achieved, for example, by the processor 110, and the packet transmission/reception unit 150 is achieved, for example, by the NIC 160. The processing content table 145 is stored, for example, in the processor 110. In addition, when the processor 110 is a CPU including a plurality of cores, the plurality of processing units 140 may be respectively achieved by the plurality of cores, and when the processor 110 includes a plurality of CPU chips, the plurality of processing units 140 may be respectively achieved by the plurality of CPU chips. Each of the plurality of processing units 140 corresponds to a processing unit in which a plurality of packets is processed individually.

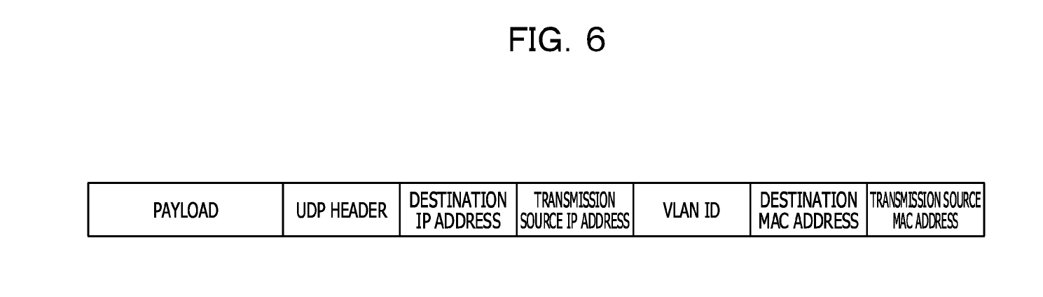

FIG. 6 is a diagram illustrating an example of a data configuration of a packet transmitted or received by the relay device 100a. The packet includes, for example, a header including information such as a user datagram protocol (UDP) header, a destination IP address, a transmission source IP address, a VLAN ID, a destination MAC address, a transmission source MAC address, in addition to a payload that is a data body portion. The destination IP address and the transmission source IP address are pieces of information included in an IP header. In addition, although not illustrated here, further piece of information, for example, type of service (TOS) and the like are included in the IP header. The header configuration illustrated in FIG. 6 is merely an example of a header configuration allowed to be applied to the embodiment.

FIG. 7 is a diagram illustrating a content example of the processing content table 145 illustrated in FIG. 5. In the processing content table 145, contents of pieces of processing executed by each of the processing units 140 at the time of allocation of a packet is defined. Here, an example is described in which a processing content is defined corresponding to a VLAN ID included in a header of a packet. First, when the processing unit 140 receives a packet, the processing unit 140 extracts a VLAN ID from a header of the packet, and refers to the processing content table 145 based on the extracted VLAN ID. As illustrated in FIG. 7, for example, in a case of a packet the VLAN ID of which is “10”, in the processing content table 145, it is determined that processing executed in the processing unit 140 includes “extraction of a destination MAC address”, “reference of a forwarding table”, and “transfer of a packet to an output port”. In addition, in a case of a packet the VLAN ID of which is “20”, in the processing content table 145, it is determined that processing executed in the processing unit 140 includes “search for a user/domain”, “deletion of a destination MAC address, a transmission source MAC address, and a VLAN ID”, “extraction of transmission source IP address and UDP port information”, “filtering based on an access list”, “extraction of an IP protocol”, “filtering of a control frame”, “extraction of a destination IP address”, “reference of a forwarding table”, “addition of a tunnel label and a user label of MPLS, and addition of a destination MAC address and a transmission source MAC address”, and “transfer of a packet to an output port”.

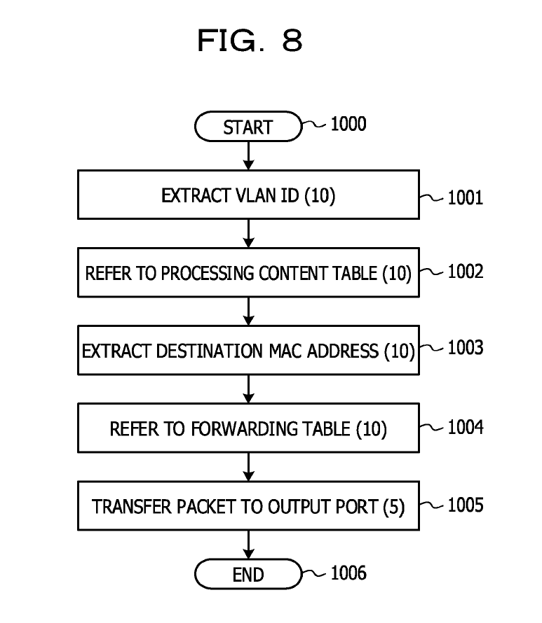

A processing flow executed by the processing unit 140 is described below based on the content of the processing content table 145 illustrated in FIG. 7. FIG. 8 is a flowchart illustrating processing of the processing unit 140 when the value of a VLAN ID included in a header of a packet that has been allocated to the processing unit 140 is “10”. The processing flow executed by the processing unit 140 is started from processing 1000, and in processing 1001, the processing unit 140 extracts a VLAN ID from the header of the packet. Next, in processing 1002, the processing unit 140 refers to the processing content table 145 based on the extracted VLAN ID. In the processing 1002, the processing unit 140 recognizes a content of processing to be executed by the processing unit 140 and executes the following processing. In processing 1003, the processing unit 140 extracts a destination MAC address from the header of the packet. Next, in processing 1004, the processing unit 140 refers to a forwarding table indicating a correspondence relationship between a destination MAC address and an output port. In addition, in processing 1005, the processing unit 140 transmits the packet to a certain port associated with the destination MAC address in the forwarding table, and the processing 1006 ends.

In FIG. 8, the numeric value set forth in parentheses for each of the pieces of processing indicates, the number of clocks desired for execution of each of the pieces of processing by the processing unit 140 as an example of a value indicating the weight of load of each of the pieces of processing, that is, a value of processing cost. The numeric value illustrated in FIG. 8 is an example, and a value of processing cost may be different depending on a method in which a processing content is executed. The example of FIG. 8 indicates that a 10 clock portion time is taken for the extraction processing of an VLAN ID, a 10 clock portion time is taken for the reference processing of the processing content table 145, a 10 clock portion time is taken for the extraction processing of a destination MAC address, a 10 clock portion time is taken for the reference processing of a forwarding table, and a 5 clock portion time is taken for the transfer processing of a packet to an output port. Therefore, the total time taken for all of the pieces of the processing 1001 to 1005 becomes a 45 clock portion time. In the embodiment, the total value of the processing cost, that is, the time taken for all of the pieces of processing is used for evaluation of the processing load of the processing unit 140.

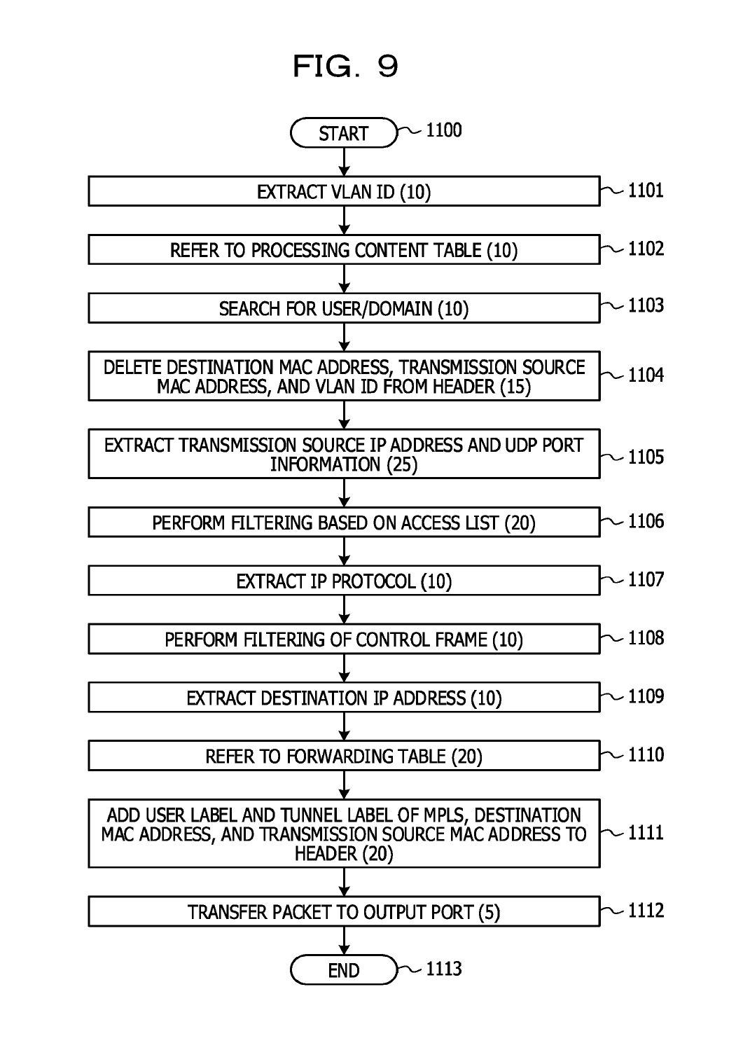

FIG. 9 is a flowchart illustrating processing of the processing unit 140 when the value of a VLAN ID included in a header of a packet information that has been allocated to the processing unit 140 is “20”. The processing flow executed by the processing unit 140 is started from processing 1100, and in processing 1101, the processing unit 140 extracts a VLAN ID from the header of the packet. Next, in processing 1102, the processing unit 140 refers to the processing content table 145 based on the extracted VLAN ID. In processing 1102, the processing unit 140 recognizes a processing content to be executed by the processing unit 140, and executes the following processing. In processing 1103, the processing unit 140 identifies a user or a domain to which the VLAN ID has been allocated, based on the extracted VLAN ID. Next, in processing 1104, the processing unit 140 deletes a destination MAC address, a transmission source MAC address, and the VLAN ID from the header. Next, in processing 1105, the processing unit 140 extracts a transmission source IP address and UDP port information from the header. Next, in processing 1106, the processing unit 140 executes filtering processing based on an access list. Next, in processing 1107, the processing unit 140 extracts an IP protocol from the header, and determines whether the packet is a data system packet or a control system packet. Next, in processing 1108, the processing unit 140 executes filtering processing of a control frame. Here, when the packet is a control system packet, the packet is terminated without being transferred to the next node. Next, in processing 1109, the processing unit 140 extracts a destination IP address from the header. Next, in processing 1110, the processing unit 140 refers to a forwarding table in which a correspondence relationship between the destination IP address and a MAC address of a next hop is defined. Next, in processing 1111, the processing unit 140 adds a tunnel label and a user label of MPLS, the transmission source MAC address, and the destination MAC address to the header of the packet. Next, in processing 1112, the processing unit 140 transfers the packet to the output port, and the processing 1113 ends.

Even in FIG. 9, similarly to FIG. 8, the numeric value set forth in parentheses for each of the pieces of processing indicates the number of clocks taken for execution of each of the pieces of processing by the processing unit, as an example of a value of a processing cost of each of the pieces of processing. In the example of FIG. 9, a 10 clock portion time is taken for the extraction processing of a VLAN ID, a 10 clock portion time is taken for the reference processing of the processing content table 145, a 10 clock portion time is taken for the identification processing of a user or a domain, a 15 clock portion time is taken for the deletion processing of a destination MAC address, a transmission source MAC address, and a VLAN ID, a 25 clock portion time is taken for the extraction processing of a transmission source IP address and UDP port information, a 20 clock portion time is taken for the filtering processing based on an access list, a 10 clock portion time is taken for the extraction processing of an IP protocol, a 10 clock portion time is taken for the filtering processing of a control frame, a 10 clock portion time is taken for the extraction processing of a destination IP address, a 20 clock portion time is taken for the reference processing of a forwarding table, a 20 clock portion time is taken for the addition processing of a tunnel label and a user label of MPLS, a transmission source MAC address, and a destination MAC address, and a 5 clock portion time is taken for the transfer processing of the packet to the output port. Therefore, the total time taken for all of the pieces of the processing 1101 to 1112 becomes a 165 clock portion time.

As described above, different processing is executed depending on a VLAN ID of a packet, so that a processing cost of the packet is different depending on the VLAN ID. Therefore, in the embodiment, a processing cost of a packet is obtained in advance for each VLAN ID, and the processing cost of the packet may be estimated by referring to the VLAN ID that has been written to the header of the packet at the time of reception of the packet. For example, when the processor 110 is a CPU, and functions as the processing unit 140 by executing a computer program, the processing cost taken for processing of a packet may be estimated by analyzing a source code of the computer program. In addition, when the processor 110 is a dedicated circuit such as an ASIC, the processing cost may be estimated based on the number of stages of flip-flop (FF) circuits constituting a circuit that executes each of the pieces of processing. Alternatively, the processing cost may also be estimated by measuring a time actually taken for the processing by processor 110.

The method in which the processing cost of the received packet is obtained is described above. A method in which the relay device 100a executes distribution processing of a plurality of packets using an obtained processing cost of a packet is described below.

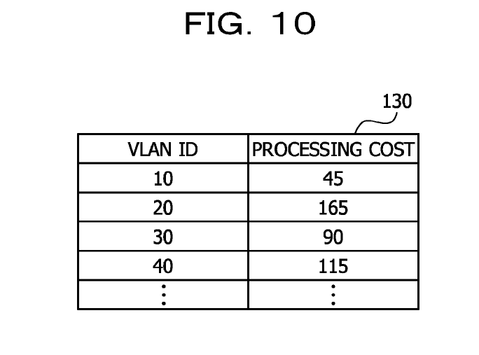

FIG. 10 is an example of a table in which a correspondence relationship between a VLAN ID and a processing cost is defined. As described in FIGS. 8 and 9, the processing cost of the packet is obtained in advance, and a processing cost table 130 indicating a correspondence relationship between a VLAN ID and a processing cost is stored in the processor 110. In the example of FIG. 10, it is indicated that a processing cost of a packet the VLAN ID of which is “10” is “45”, and a processing cost of a packet the VLAN ID of which is “20” is “165”, a processing cost of a packet the VLAN ID of which is “30” is “90”, and a processing cost of a packet the VLAN ID of which is “40” is “115”.

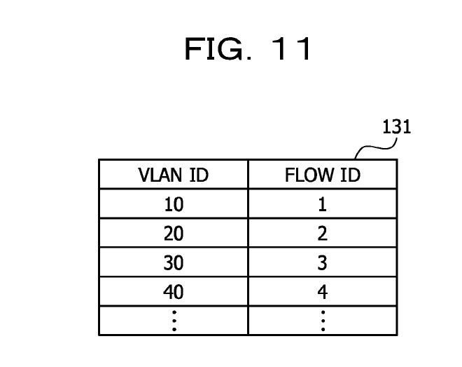

FIG. 11 is an example of a table in which a correspondence relationship between a VLAN ID and a flow ID is defined. A flow ID is allocated to each VLAN ID, and a flow ID table 131 in which a correspondence relationship between a VLAN ID and a flow ID is defined is stored in the processor 110. In the example of FIG. 11, it is indicated that a flow ID of a packet the VLAN ID of which is “10” is defined as “1”, the flow ID of a packet the VLAN ID of which is “20” is defined as “2”, the flow ID of a packet the VLAN ID of which is “30” is defined as “3”, and the flow ID of a packet the VLAN ID of which is “40” is defined as “4”.

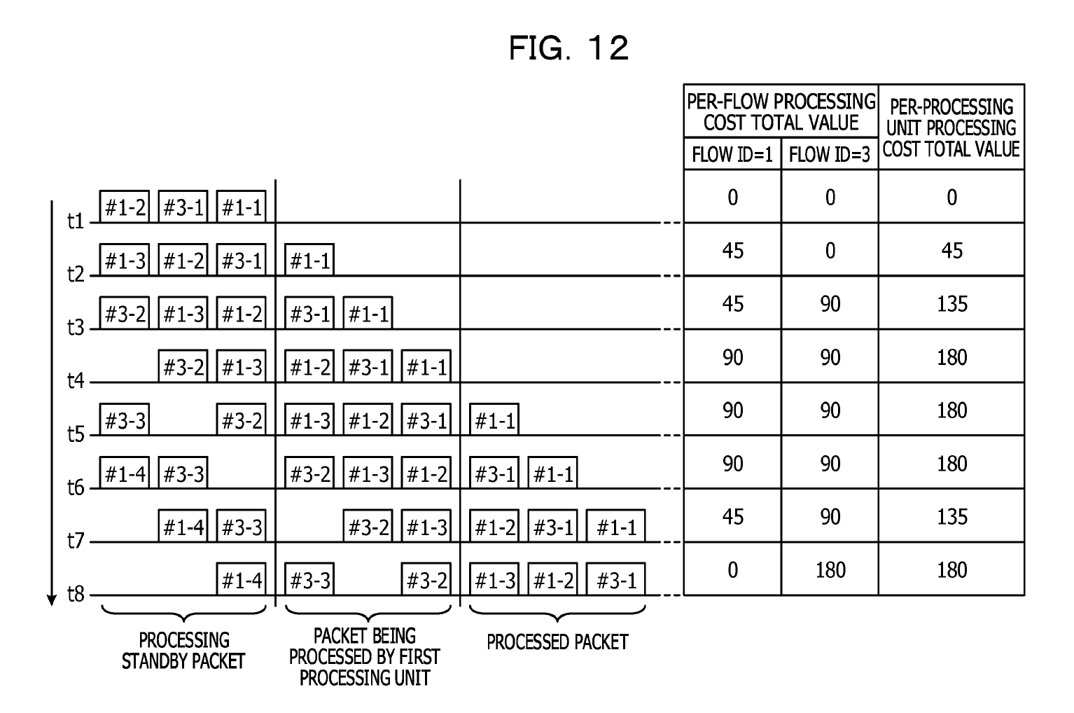

FIG. 12 is a diagram illustrating a count method of a processing cost of a packet that is being processed. Here, an example is described in which a plurality of packets the flow ID of which is “1” and a plurality of packets the flow ID of which is “3” are allocated to the first processing unit 140a. In FIG. 12, it is indicated that a packet represented by “#x-y” is the y-th packet from among a plurality of packets the flow ID of which is “x”. In addition, in FIG. 12, “processing standby packet” indicates a packet in a state before being allocated from the load distribution unit 120 to the first processing unit 140a, and “processing packet” indicates a packet in a state of being processed by the first processing unit 140a, and “processed packet” indicates a packet in a state of having been processed by the first processing unit 140a. In addition, in FIG. 12, “per-flow processing cost total value” indicates a value that has been obtained by calculating a total value of processing costs of packets that are being processed in the first processing unit 140a for each of the flows (here, each of the flow the flow ID of which is “1” and the flow the flow ID of which is “3”), and “per-processing unit processing cost total value” indicates a total value of processing costs of all packets that are being processed in each of the processing units 140 (here, the first processing unit 140a). As illustrated in FIG. 10, it is assumed that the processing cost of a packet the flow ID of which is “1” is “45”, and the processing cost of a packet the flow ID of which is “3” is “90”.

First, at a time t1, a packet #1-1, a packet #3-1, and a packet #1-2 are in the processing standby state. At this point, the first processing unit 140a is yet to process any packets. Therefore, a per-flow processing cost total value in which the flow ID is “1” is “0”, and a per-flow processing cost total value in which the flow ID is “3” is also “0”, so that a per-processing unit processing cost total value of the first processing unit 140a becomes “0”.

Next, at a time t2, the packet #1-1 is allocated to the first processing unit 140a. In addition, the packet #1-1 is determined to be in the state of being processed in the first processing unit 140a, and the processing cost “45” of the packet #1-1 is added to the per-flow processing cost total value in which the flow ID is “1”. At this point, the per-flow processing cost total value in which the flow ID is “3” is “0”, so that the per-processing unit processing cost total value becomes “45”.

Next, at the time t3, the packet #3-1 is allocated to the first processing unit 140a. At this point, the packet #3-1 is determined to be in the state of being processed in the first processing unit 140a, and the processing cost “90” of the packet #3-1 is added to the per-flow processing cost total value in which the flow ID is “3”. At this point, the processing of the packet #1-1 in the first processing unit 140a is yet to be completed, so that the per-flow processing cost total value in which the flow ID is “1” remains “45”, so that the per-processing unit processing cost total value becomes “135”.

Next, at the time t4, the packet #1-2 is allocated to the first processing unit 140a. In addition, the processing cost “45” of the packet #1-2 is added to the per-flow processing cost total value in which the flow ID is “1”. At this point, the processing of the packet #1-1 in the first processing unit 140a is yet to be completed, so that the per-flow processing cost total value in which the flow ID is “1” becomes “90”. In addition, at this point, the processing of the packet #3-1 in the first processing unit 140a is also yet to be completed, so that the per-flow processing cost total value in which the flow ID is “3” remains “90”, so that the per-processing unit processing cost total value becomes “180”.

Next, at the time t5, a packet #1-3 is allocated to the first processing unit 140a. In addition, the processing cost “45” of the packet #1-3 is added to the per-flow processing cost total value in which the flow ID is “1”. In addition, the processing of the packet #1-1 in the first processing unit 140a has been completed, so that the processing cost “45” of the packet #1-1 is subtracted from the per-flow processing cost total value in which the flow ID is “1”, and as a result, the per-flow processing cost total value in which the flow ID is “1” becomes “90”. At this point, the processing of the packet #3-1 is yet to be completed, so that the per-flow processing cost total value in which the flow ID is “3” remains “90”, and the per-processing unit processing cost total value becomes “180”.

As described above, when the packet is allocated to the first processing unit 140a, the value of the processing cost of the packet is added to the corresponding per-flow processing cost total value, and when the first processing unit 140a has completed the processing of the packet, the value of the processing cost of the packet is subtracted from the corresponding per-flow processing cost total value. By such a method, a total value of processing costs of packets that are actually being processed in a certain processing unit 140 may be obtained. In addition, a total value of processing costs of packets in a certain processing unit 140 may be obtained for each flow ID.

In addition, at the time t8, there is no packet the flow ID of which is “1” and is processed by the first processing unit 140a, and the per-flow processing cost total value in which the flow ID is “1” becomes “0”. Therefore, when an allocation destination of a packet #1-4 that is a subsequent packet the flow ID of which is “1” is changed to a further processing unit 140 other than the first processing unit 140a at this timing, a change in processing order of the packets may be avoided. Here, when a processing unit 140 as an allocation destination of a packet is selected, the per-processing unit processing cost total value that has been calculated for each of the processing units 140 is used. In FIG. 12, merely the per-processing unit processing cost total value of the first processing unit 140a is illustrated, but per-processing unit processing cost total values for the second processing unit 140b and the third the processing unit 140c may be obtained by a similar method. In addition, the per-processing unit processing cost total values of the processing units 140 at the time t8 are compared to each other, and a processing unit 140 having the smallest per-processing unit processing cost total value is selected as the allocation destination of the packet #1-4.

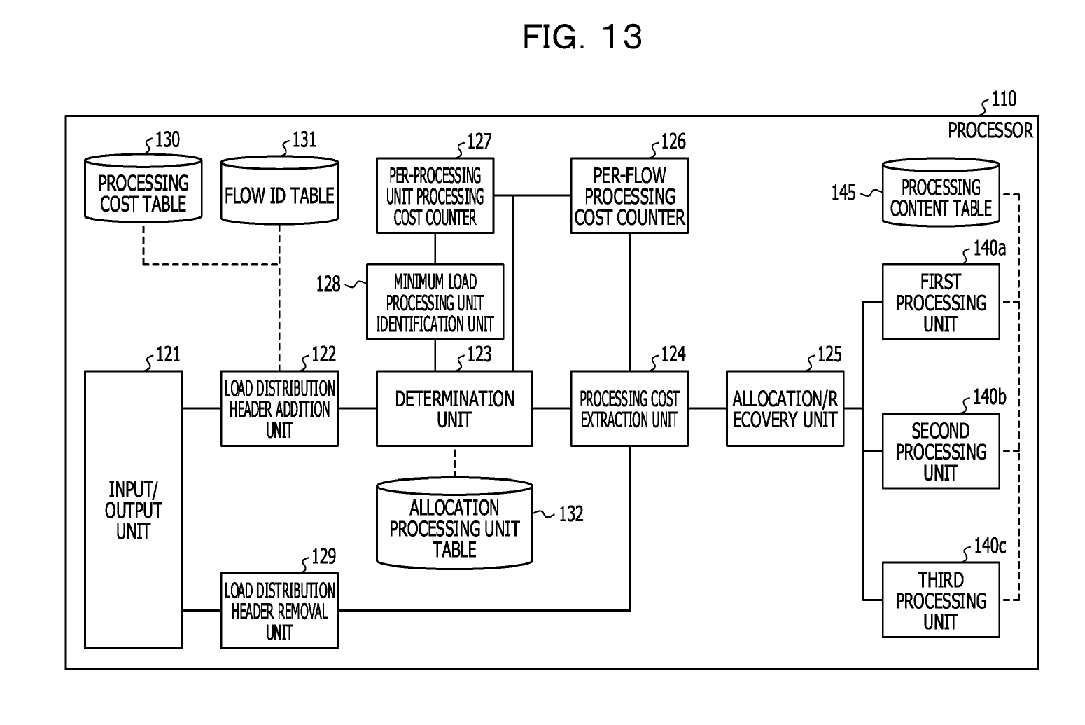

FIG. 13 is a functional block diagram of the processor 110. When the processor 110 is a CPU, the processor 110 functions as an input/output unit 121, a load distribution header addition unit 122, a determination unit 123, a processing cost extraction unit 124, an allocation/recovery unit 125, a per-flow processing cost counter 126, a per-processing unit processing cost counter 127, a minimum load processing unit identification unit 128, and a load distribution header removal unit 129 by executing a computer program that has been loaded to the volatile memory 170. These function blocks are included in the load distribution unit 120 illustrated in FIG. 5. In addition, the processor 110 stores the processing cost table 130 illustrated in FIG. 10 and the flow ID table 131 illustrated in FIG. 11. In addition, the processor 110 functions as the first processing unit 140a, the second processing unit 140b, and the third the processing unit 140c illustrated in FIG. 5, and stores the processing content table 145. In addition, the processor 110 stores an allocation processing unit table 132 illustrated in FIG. 13, which is described later.

In the following description, for simplicity of explanation, expressions such as “received packet” and “preceding packet” are used as appropriate. Here, “received packet” indicates a target packet for a description of a processing content by the load distribution unit 120 and the processing unit 140, and “preceding packet” indicates a packet that has been input to the relay device before the received packet and the processing of which has been already completed or that is currently being processed by the processing unit 140.

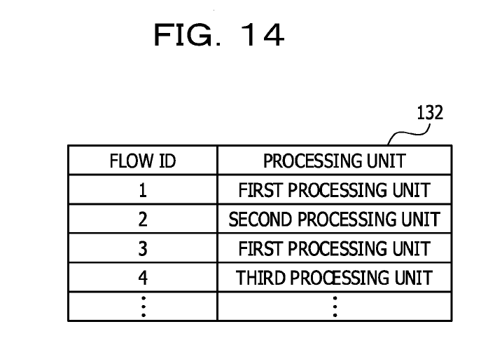

The input/output unit 121 receives a packet that has been input from a further node. In addition, the input/output unit 121 transmits a packet for which certain processing has been completed in the processing unit 140, to a further node though the NIC 160. The load distribution header addition unit 122 extracts a VLAN ID of the packet that has been received from the input/output unit 121, and identifies a flow ID and a processing cost of the received packet by referring to the processing cost table 130 and the flow ID table 131. In addition, the load distribution header addition unit 122 adds a load distribution header to the received packet, and writes the flow ID and the processing cost to the load distribution header. The determination unit 123 extracts the flow ID that has been written to the load distribution header of the packet. In addition, the determination unit 123 determines an allocation destination of the received packet, based on the count value of the per-flow processing cost counter 126, the count value of the per-processing unit processing cost counter 127, and the content of the allocation processing unit table 132. The per-flow processing cost counter 126 is a counter that counts a per-flow processing cost total value. When a value of the per-flow processing cost counter 126 related to a preceding packet having the same flow ID as the received packet is other than “0”, the determination unit 123 refers to the allocation processing unit table 132. The allocation processing unit table 132 stores information used to identify a flow ID of the preceding packet and a processing unit 140 to which the preceding packet has been allocated. FIG. 14 is a diagram illustrating a content example of the allocation processing unit table 132. In FIG. 14, it is indicated that a preceding packet the flow ID of which is “1” and a preceding packet the flow ID of which is “3” are allocated to the first processing unit 140a, and a preceding packet the flow ID of which is “2” is allocated to the second processing unit 140b, and a preceding packet the flow ID of which is “4” is allocated to the third the processing unit 140c.

Returning to the description of FIG. 13, when a per-flow processing cost total value related to the preceding packet having the same flow ID as the received packet is other than “0”, the determination unit 123 refers to the allocation processing unit table 132, and allocates the received packet to the processing unit 140 to which the preceding packet has been allocated. In addition, when the per-flow processing cost total value related to the preceding packet having the same flow ID as the received packet is “0”, the determination unit 123 allocates the received packet to a processing unit 140 identified by the minimum load processing unit identification unit 128. The minimum load processing unit identification unit 128 selects the processing unit 140 having the smallest per-processing unit processing cost total value, based on the count value of the per-processing unit processing cost counter 127, and notifies the determination unit 123 of the selected processing unit 140. The per-processing unit processing cost counter 127 counts the per-processing unit processing cost total value for each of the processing units 140, based on the count value of the per-flow processing cost counter 126.

The determination unit 123 writes the processing unit ID to the load distribution header of the received packet, as information used to identify the processing unit 140 that has been selected by the above-described determination method. The processing cost extraction unit 124 receives the packet from the determination unit 123, extracts the flow ID, the processing cost, and the processing unit ID from the load distribution header, and notifies the per-flow processing cost counter 126 of the extracted pieces of information. The per-flow processing cost counter 126 adds the processing cost that has been notified from the processing cost extraction unit 124 to the per-flow processing cost total value for each of the flow IDs to calculate the per-flow processing cost total value. In addition, the per-processing unit processing cost counter 127 receives the notification of the processing costs from the per-flow processing cost counter 126, and adds the processing cost to the per-flow processing cost total value for each of the processing units to calculate the per-processing unit processing cost total value. The minimum load processing unit identification unit 128 identifies a processing unit 140 having the smallest processing cost total value, based on the count result of the per-processing unit processing cost counter 127. The per-processing unit processing cost counter 127 may receive the notification of the processing cost from the processing cost extraction unit 124 directly.

The processing cost extraction unit 124 delivers the received packet to the allocation/recovery unit 125. The allocation/recovery unit 125 allocates the received packet to a processing unit 140 identified by the processing unit ID that has been written to the load distribution header. In addition, the allocation/recovery unit 125 receives the processed packet from each of the processing units 140, and transmits the packet to the processing cost extraction unit 124. The processing cost extraction unit 124 extracts the flow ID, the processing cost, and the processing unit ID from the load distribution header of the received packet, and notifies the per-flow processing cost counter 126 of the extracted pieces of information. The per-flow processing cost counter 126 subtracts the processing cost that has been notified from the processing cost extraction unit 124, from the per-flow processing cost total value for each of the corresponding flow IDs. In addition, the per-processing unit processing cost counter 127 subtracts the processing cost from the per-processing unit processing cost total value for each of the processing units to calculate the per-processing unit processing cost total value.

In addition, the processing cost extraction unit 124 transmits the packet that has been received from the allocation/recovery unit 125 to the load distribution header removal unit 129. The load distribution header removal unit 129 removes the load distribution header from the received packet, and transmits the obtained packet to the input/output unit 121. The input/output unit 121 transmits the received packet to the packet transmission/reception unit 150.

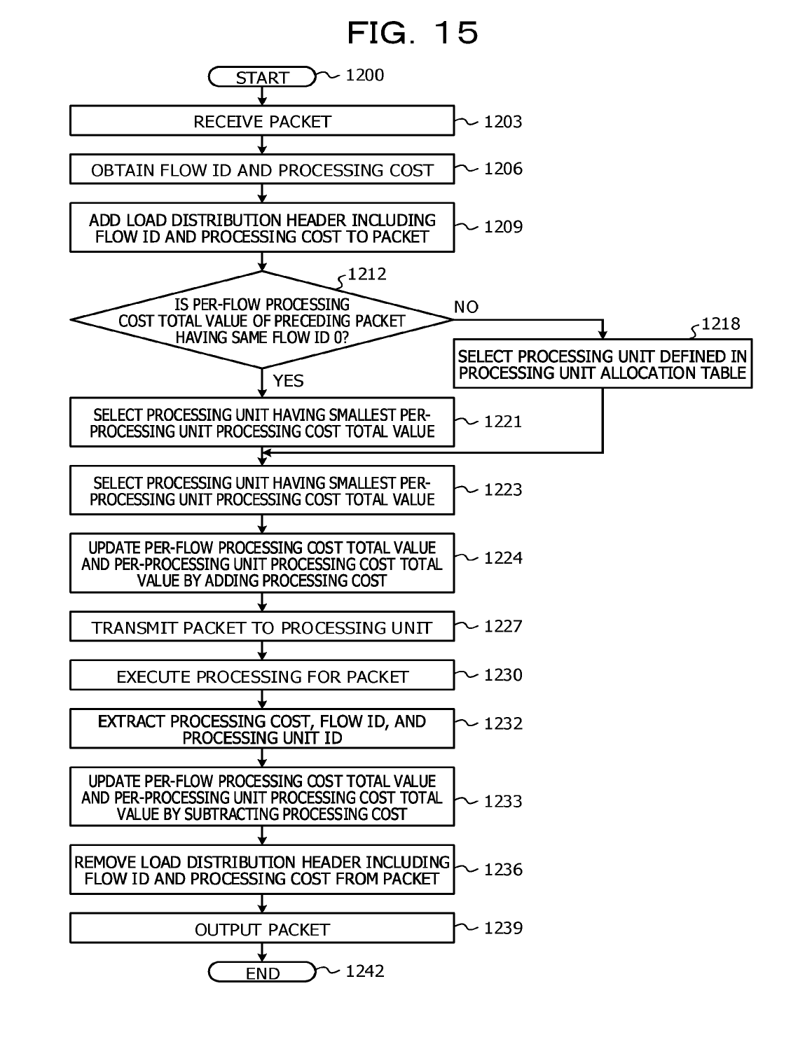

FIG. 15 is a diagram illustrating a flowchart of processing executed by the processor 110. The processing flow executed by the processor 110 is started from processing 1200, and in processing 1203, the input/output unit 121 receives a packet. In processing 1206, the load distribution header addition unit 122 refers to the processing cost table 130 and the flow ID table 131, and obtains a flow ID and a processing cost, based on a VLAN ID that has been written to a header of the received packet. In processing 1209, the load distribution header addition unit 122 adds a load distribution header including the flow ID and the processing cost to the received packet. In processing 1212, the determination unit 123 determines whether a per-flow processing cost total value of a preceding packet having the same flow ID as the received packet is “0”, based on the count value of the per-flow processing cost counter 126.

In processing 1212, when it is determined that the per-flow processing cost total value is not “0”, the processing proceeds to processing 1218, and when it is determined that the per-flow processing cost total value is “0”, the processing proceeds to processing 1221. In processing 1218, the determination unit 123 refers to the allocation processing unit table 132, and selects a processing unit 140 in which the preceding packet having the same flow ID as the received packet is currently being processed, as an allocation destination of the received packet. At that time, the determination unit 123 writes the processing unit ID to the load distribution header, as information used to identify a selected processing unit 140. In processing 1221, the determination unit 123 selects a processing unit 140 having the smallest per-processing unit processing cost total value as an allocation destination of the received packet, based on the notification content of the minimum load processing unit identification unit 128, and writes the processing unit ID of the selected processing unit 140 to the load distribution header.

In processing 1223, the processing cost extraction unit 124 extracts the processing cost, the flow ID, and the processing unit ID from the load distribution header of the received packet, and notifies the per-flow processing cost counter 126 of the extracted pieces of information. In processing 1224, the per-flow processing cost counter 126 updates the per-flow processing cost total value by adding the notified processing cost to the per-flow processing cost total value. In addition, in processing 1224, the per-processing unit processing cost counter 127 updates the per-processing unit processing cost total value by adding the processing cost that has been notified from the per-flow processing cost counter 126 or the processing cost extraction unit 124 to the per-processing unit processing cost total value. In processing 1227, the allocation/recovery unit 125 transmits the received packet to the selected processing unit 140. In processing 1230, the processing unit 140 to which the received packet has been allocated executes processing for the packet based on the content of the processing content table 145. In processing 1232, the processing cost extraction unit 124 receives the packet for which the processing has been completed, from the processing unit 140 through the allocation/recovery unit 125. In addition, in processing 1232, the processing cost extraction unit 124 extracts the processing cost, the flow ID, and the processing unit ID from the load distribution header of the received packet and notifies the per-flow processing cost counter 126 of the extracted pieces of information. In processing 1233, the per-flow processing cost counter 126 updates the per-flow processing cost total value by subtracting the notified processing cost from the per-flow processing cost total value. In addition, in processing 1233, the per-processing unit processing cost counter 127 updates the per-processing unit processing cost total value by subtracting the processing cost that has been notified from the per-flow processing cost counter 126 or the processing cost extraction unit 124, from the per-processing unit processing cost total.

In processing 1236, the load distribution header removal unit 129 removes the load distribution header including the flow ID, the processing cost, and the processing unit ID from the packet. In addition, in processing 1239, the input/output unit 121 performs output of the packet, and the processing 1242 ends.

As described above, in the first embodiment, the processing cost of a packet is obtained for each flow in advance, and the processing cost of a received packet may be estimated by identifying a flow ID of the received packet. In addition, for each of the processing units, the per-processing unit processing cost total value is calculated by adding the processing cost of a received packet to the per-processing unit processing cost total value when the received packet has been allocated to the processing unit or subtracting the processing cost of a received packet from the per-processing unit processing cost total value when the processing of the received packet has been completed. When the per-processing unit processing cost total values for the processing units are compared to each other, the received packet may be allocated to the processing unit 140 having the smallest per-processing unit processing cost total value.

In the first embodiment, the method is described above in which a plurality of packets having an identical VLAN ID is identified to belong to an identical flow. In addition, for example, a plurality of packet having an identical combination of a destination node and a transmission source node may be identified to belong to an identical flow. In this case, for example, a flow may be identified by a combination of a destination IP address and a transmission source IP address.

In addition, in the first embodiment, when the processor 110 is a multi-core CPU chip including a plurality of CPU cores, the plurality of CPU cores may respectively function as the plurality of processing units 140. In addition, when the processor 110 includes a plurality of CPU chips formed individually, the plurality of CPU chips may respectively function as the plurality of processing units 140.

In addition, in the first embodiment, the example is descried above in which the processing unit 140 having the smallest per-processing unit processing cost total value is selected when the per-flow processing cost total value becomes “0”, but other implementation is also possible beside selecting the processing unit 140 having the smallest per-processing unit processing cost total value. For example, any processing unit 140 having a smaller per-processing unit processing cost total value than the per-processing unit processing cost total value of the processing unit 140 that is currently being specified as the allocation destination may be selected as a new allocation destination. In addition, any processing unit 140 having a smaller per-processing unit processing cost total value by a certain amount or more, than the per-processing unit processing cost total value of the processing unit 140 that is currently being specified as the allocation destination may be selected as a new allocation destination.

### Second Embodiment

In the first embodiment, the method is described above in which a processing cost is subtracted from the per-flow processing cost total value and the per-processing unit processing cost total value when the load distribution unit 120 receives a packet in which the processing has been completed, from the processing unit 140. In a second embodiment, a method is described below in which the per-flow processing cost counter 126 and the per-processing unit processing cost counter 127 update the total values appropriately even when the load distribution unit 120 does not receive a packet in which the processing has been completed from the processing unit 140.

The case in which the processing cost extraction unit 124 does not receive a packet from the processing unit 140 is a case in which the processing unit 140 terminates or discards the packet. For example, the case includes a case in which a packet that has been received at the relay device 100a is a control system packet, and the relay device 100a is regarded as a destination. In such a case, the packet is terminated or discarded in the processing unit 140, and the packet in which the processing has been completed is not sent back to the load distribution unit 120. In the second embodiment, a method is described below in which a processing cost is subtracted from a per-flow processing cost total value and a per-processing unit processing cost total value even when the packet has been terminated or discarded in the processing unit 140.

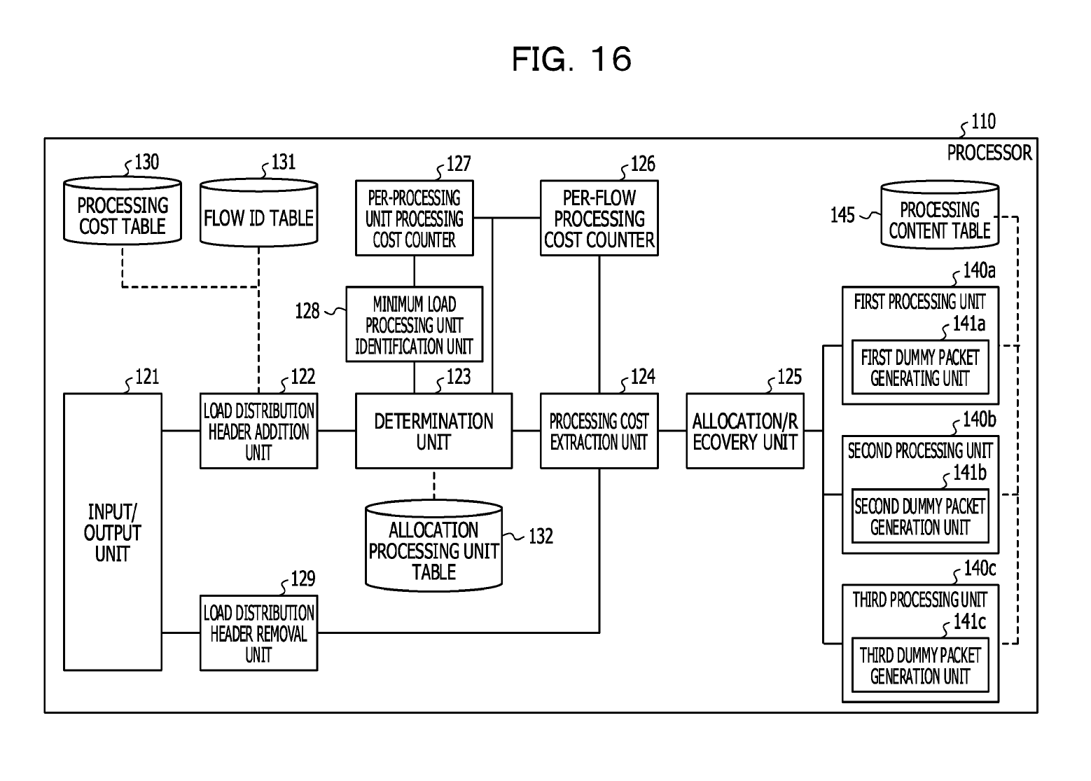

FIG. 16 is a diagram illustrating a function block of a processor 110 according to the second embodiment. In the second embodiment, a first the dummy packet generation unit 141a, a second the dummy packet generation unit 141b, and a third the dummy packet generation unit 141c are respectively provided in the first processing unit 140a, the second processing unit 140b, the third the processing unit 140c. In the embodiment, when there is no intention that any of the first dummy packet generation unit 141a, the second the dummy packet generation unit 141b, and the third the dummy packet generation unit 141c are not specified, the dummy packet generation unit is referred to as “dummy packet generation unit 141”.

When an allocated packet is a terminated or discarded packet in the relay device 100a, the dummy packet generation unit 141 generates a dummy packet. Contents that have been obtained by copying at least of a processing cost, a flow ID, and a processing unit ID included in the header of the allocated packet are written to the header of the dummy packet. In addition, a flag indicating that the packet is a dummy packet is also written to the header of the dummy packet. In addition, the processing unit 140 transmits the dummy packet to the processing cost extraction unit 124 through the allocation/recovery unit 125. When the processing cost extraction unit 124 receives the dummy packet, the processing cost extraction unit 124 extracts the processing cost, the flow ID, and the processing unit ID from the header of the dummy packet, and notifies the per-flow processing cost counter 126 and the per-processing unit processing cost counter 127 of the extracted pieces of information. The per-flow processing cost counter 126 and the per-processing unit processing cost counter 127 respectively update the per-flow processing cost total value and the per-processing unit processing cost total value by subtracting the notified processing cost from the per-flow processing cost total value and the per-processing unit processing. In addition, the processing cost extraction unit 124 recognizes that the received packet is a dummy packet due to the flag of the header of the packet, and discards the dummy packet without transmitting the dummy packet to the load distribution header removal unit 129.

As a result, even when the packet is a packet terminated or discarded in the relay device 100a, the per-flow processing cost total value and the per-processing unit processing cost total value may be updated appropriately.

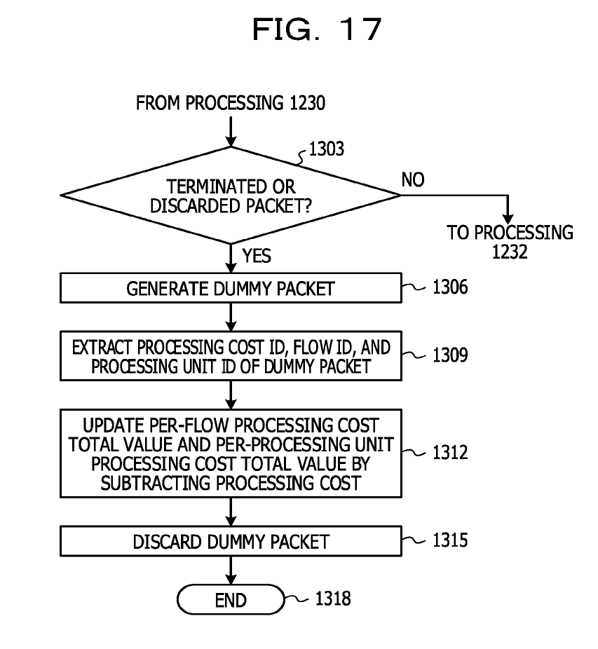

FIG. 17 is a flowchart of processing by the processor 110 according to the second embodiment. The flowchart in the second embodiment is identical to the flowchart in the first embodiment described with reference to FIG. 15 in that of the pieces of processing 1200 to 1230, so that the processing 1230 and pieces of subsequent processing are described below. After the processing 1230, in processing 1303, the processing unit 140 determines whether the processed packet is a terminated or discarded packet. In processing 1303, when it is determined that the packet is not a terminated or discarded packet, the processing proceeds to processing 1232. In addition, in processing 1303, when it is determined that the packet is a terminated or discarded packet, the processing proceeds to processing 1306. In processing 1306, the dummy packet generation unit 141 generates a dummy packet. In processing 1309, the processing cost extraction unit 124 extracts a processing cost ID, a flow ID, and a processing unit ID from the header of the dummy packet, and notifies the per-flow processing cost counter 126 and the per-processing unit processing cost counter 127 of the extracted pieces of information. In processing 1312, the per-flow processing cost counter 126 and the per-processing unit processing cost counter 127 respectively update the per-flow processing cost total value and the per-processing unit processing cost total value by subtracting the processing cost from the per-flow processing cost total value and the per-processing unit processing cost total value. In processing 1315, the processing cost extraction unit 124 discards the dummy packet, and the processing 1318 ends.

As described above, in the second embodiment, even when the received packet is a terminated or discarded packet, the per-flow processing cost total value and the per-processing unit processing cost total value may be updated.

### Third Embodiment

In the second embodiment, the load distribution unit 120 recognizes whether a packet has been terminated or discarded due to generation of a dummy packet by the processing unit 140. In the third embodiment, when there is no response for a packet from the processing unit 140 even when a certain time period elapses after the load distribution unit 120 has transmitted the packet to the processing unit 140, the load distribution unit 120 determines that the packet has been terminated or discarded. In addition, the per-flow processing cost total value and the per-processing unit processing cost total value are updated.

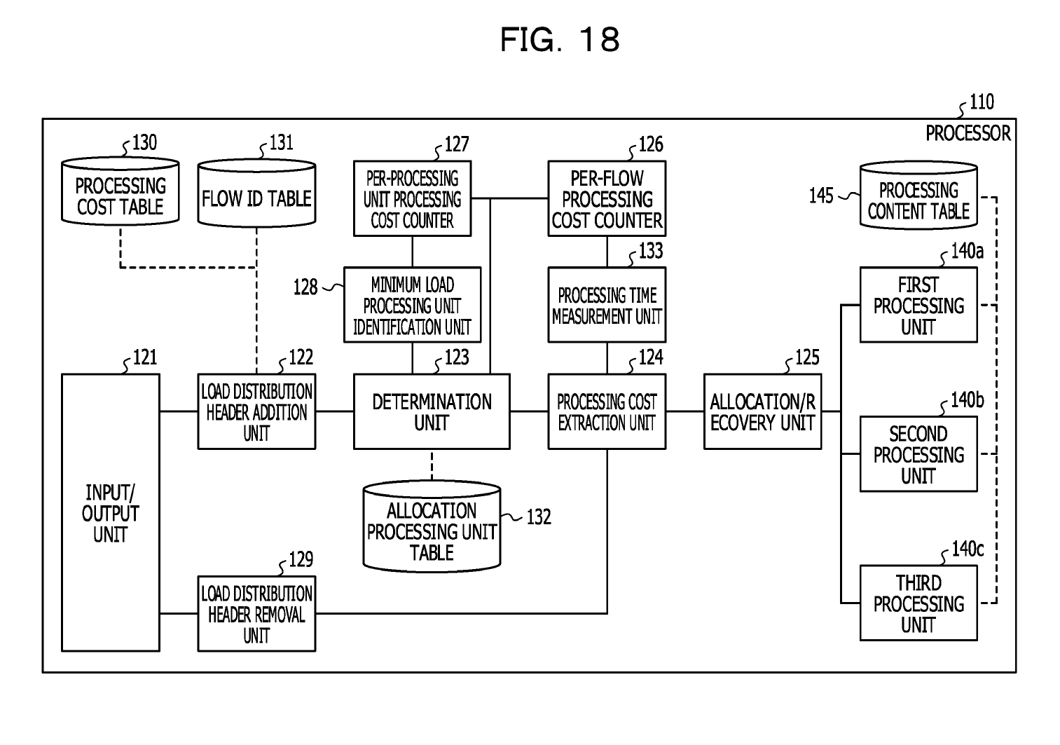

FIG. 18 is a diagram illustrating a function block of a processor 110 according to the third embodiment. The same reference numeral is assigned to the same function block as the function block illustrated in FIG. 13 of the first embodiment, and the description is omitted herein. When the processor 110 is a CPU, each of the function blocks illustrated in FIG. 18 is achieved by causing the processor 110 to execute a computer program that has been loaded to the volatile memory 170. The processor 110 functions as a processing time measurement unit 133 in addition to the functions illustrated in FIG. 13. In addition, in the third embodiment, the load distribution header addition unit 122 writes a packet ID used to individually recognize a packet to the load distribution header. In addition, when the processing cost extraction unit 124 transmits the packet to the processing unit 140 through the allocation/recovery unit 125, the processing cost extraction unit 124 extracts the packet ID from the load distribution header in addition to a processing cost, a flow ID, and a processing unit ID, and notifies the processing time measurement unit 133 of the extracted pieces of information. The processing time measurement unit 133 records a time at which the packet has been transmitted to the processing unit 140 as a processing start time, and measures the passage of time. In addition, in a case in which the packet is not recovered from the processing unit 140 even when a certain time elapses, it is determined that the packet has been terminated or discarded in the processing unit 140, the per-flow processing cost counter 126 and the per-processing unit processing cost counter 127 are respectively notified of subtraction of the processing cost of the packet from the per-flow processing cost total value and the per-processing unit processing cost total value. As a result, even when the packet has been terminated or discarded in the processing unit 140, and the termination or discard of the packet in the processing unit 140 has not been notified to the load distribution unit 120, the per-flow processing cost total value and the per-processing unit processing cost total value may be updated.

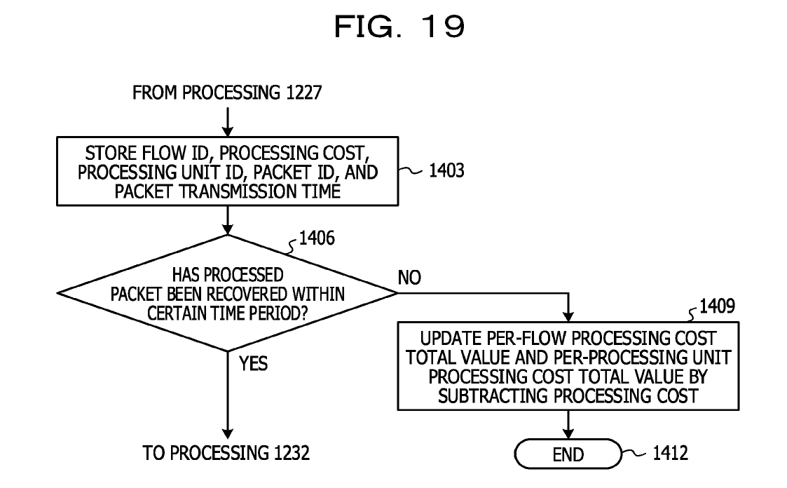

FIG. 19 is a diagram illustrating a flowchart of processing by the processor 110 according to the third embodiment. The flowchart in the third embodiment is identical to the first embodiment described with reference to FIG. 15 in that of the pieces of processing 1200 to 1227 by the processor 110, so that processing 1227 and pieces of subsequent processing are described below. After the processing 1227, in processing 1403, the processing time measurement unit 133 stores the transmission time of the packet in addition to the flow ID, the processing cost, the processing unit ID, and the packet ID. In processing 1406, the processing time measurement unit 133 determines whether the processed packet has been recovered from the processing unit 140 within a certain time period from the transmission time of the packet. In processing 1406, when it is determined that the packet has been recovered within the certain time period, the processing proceeds to processing 1232. In addition, in processing 1406, when it is determined that the packet has not been recovered within the certain time period, the processing proceeds to processing 1409. In processing 1409, the per-flow processing cost counter 126 updates the per-flow processing cost total value by subtracting the processing cost from the per-flow processing cost total value. In addition, in processing 1409, the per-processing unit processing cost counter 127 updates the per-processing unit processing cost total value by subtracting the processing cost from the per-processing unit processing cost total value. Then, the processing ends in the processing 1412. In the third embodiment, in the processing 1209, the load distribution header addition unit 122 writes the packet ID to the load distribution header in addition to the flow ID and the processing cost.

### Fourth Embodiment

In a fourth embodiment, when reception frequency of a plurality of packets having a certain flow ID is a certain value or more, a processing unit 140 that is an allocation destination is fixed, and even when the per-flow processing cost total value becomes “0”, the processing unit 140 that is the allocation destination is not changed. Here, the cache effect of the processing unit 140 is utilized. That is, in a case in which the processing unit 140 executes the processing, access speed to repeatedly-used data may be improved when the data is stored in a cache memory. In processing of a plurality of packets that belong to an identical flow ID, it is conceived that the number of times of utilization of data stored in the cache memory is increased. If a processing unit 140 that processes a plurality of packets having an identical flow ID is changed frequently, the utilization efficiency of data stored in the cache memory is reduced. Therefore, when reception frequency of a plurality of packets having an identical flow ID is a certain value or more, the processing unit 140 that is the allocation destination is not changed by considering the utilization efficiency of the cache memory.

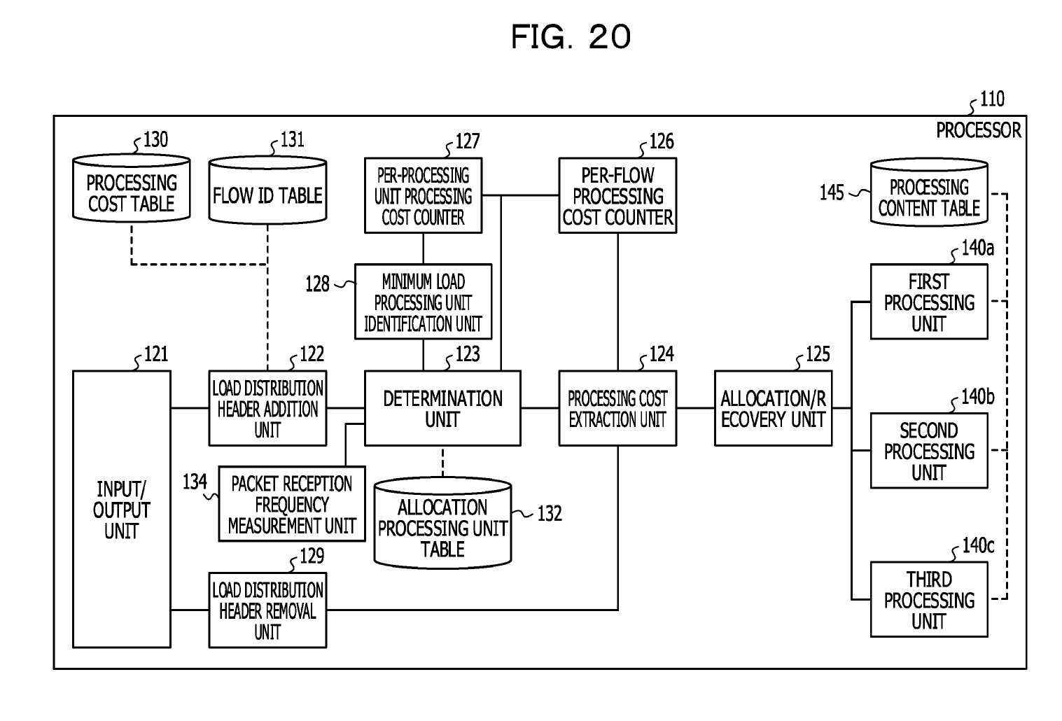

FIG. 20 is a diagram illustrating a function block of a processor 110 according to the fourth embodiment. The same reference numeral is assigned to the same function block as the function block illustrated in FIG. 13 of the first embodiment, and the description is omitted herein. When the processor 110 is a CPU, each of the function blocks illustrated in FIG. 20 is achieved by causing the processor 110 to execute a computer program that has been loaded to the volatile memory 170. The processor 110 functions as a packet reception frequency measurement unit 134 in addition to the functions illustrated in FIG. 13. It is assumed that each of the processing units 140 includes a cache memory. The packet reception frequency measurement unit 134 measures reception frequency of a plurality of packets to each of which the load distribution header has been added by the load distribution header addition unit 122, for each flow. In addition, in a case in which the reception frequency of the packets, which has been measured by the packet reception frequency measurement unit 134, becomes a certain value or more, the determination unit 123 selects the same processing unit 140 as the processing unit 140 that is the allocation destination of a preceding packet, as a transmission destination of the received packet even when the per-flow processing cost total value becomes “0”. As a result, the utilization efficiency of the cache memory in each of the processing units 140 may be improved.

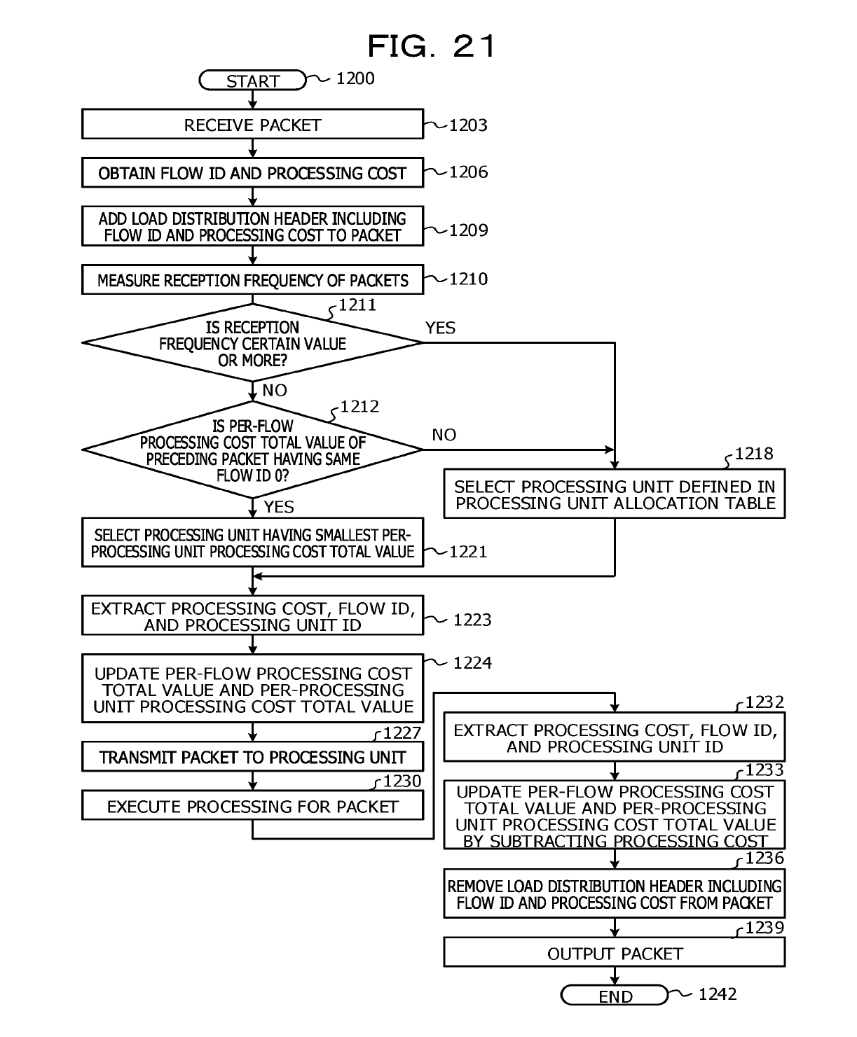

FIG. 21 is a diagram illustrating a flowchart of processing by the processor 110 according to the fourth embodiment. The same reference numeral is assigned to the same processing as the processing illustrated in FIG. 15 of the first embodiment, and the description is omitted herein. After the processing 1209, in processing 1210, the packet reception frequency measurement unit 134 measures reception frequency of packets. Such measurement is performed for each flow. In processing 1211, the determination unit 123 determines whether the reception frequency that has been measured by the packet reception frequency measurement unit 134 is a certain value or more. In processing 1211, when it has been determined that the reception frequency is less than the certain value, the processing proceeds to processing 1212. In addition, in processing 1211, when it has been determined that the reception frequency is the certain value or more, the processing proceeds to processing 1218, and a processing unit 140 is selected based on the allocation processing unit table 132.

### Fifth Embodiment

The packet lengths of a plurality of packets transmitted in a network may be not identical. For example, there is a case in which the packet length of a packet in audio communication of a telephone or the like is shorter than the packet length of a packet in file transfer of a file transfer protocol (FTP) when the packet length of the packet in the audio communication and the packet length of the packet in the file transfer are compared to each other.

In the fifth embodiment, when the proportion of short packets the packet lengths of which are certain values or less from among a plurality of packets having a certain flow ID is a certain value or less, the processing unit 140 that is the allocation destination is fixed, and even when the per-flow processing cost total value becomes “0”, the processing unit 140 that is the allocation destination is not changed. On the contrary, in a case in which the proportion of the short packets is larger than the certain value, when the per-flow processing cost total value becomes “0”, the processing unit 140 is changed. When the packet length is short, the proportion of processing other than the processing of the processing unit 140 defined in the processing content table 145 such as frequency reception of a packet, decryption of a VLAN ID, reference to the processing content table 145, and transmission of a processed packet is increased, and the processing load of the processing unit 140 is increased. Therefore, load distribution to the plurality of processing units 140 is desired. Thus, whether the processing unit 140 is changed is determined based on whether the proportion of the short packets is the certain value or less.

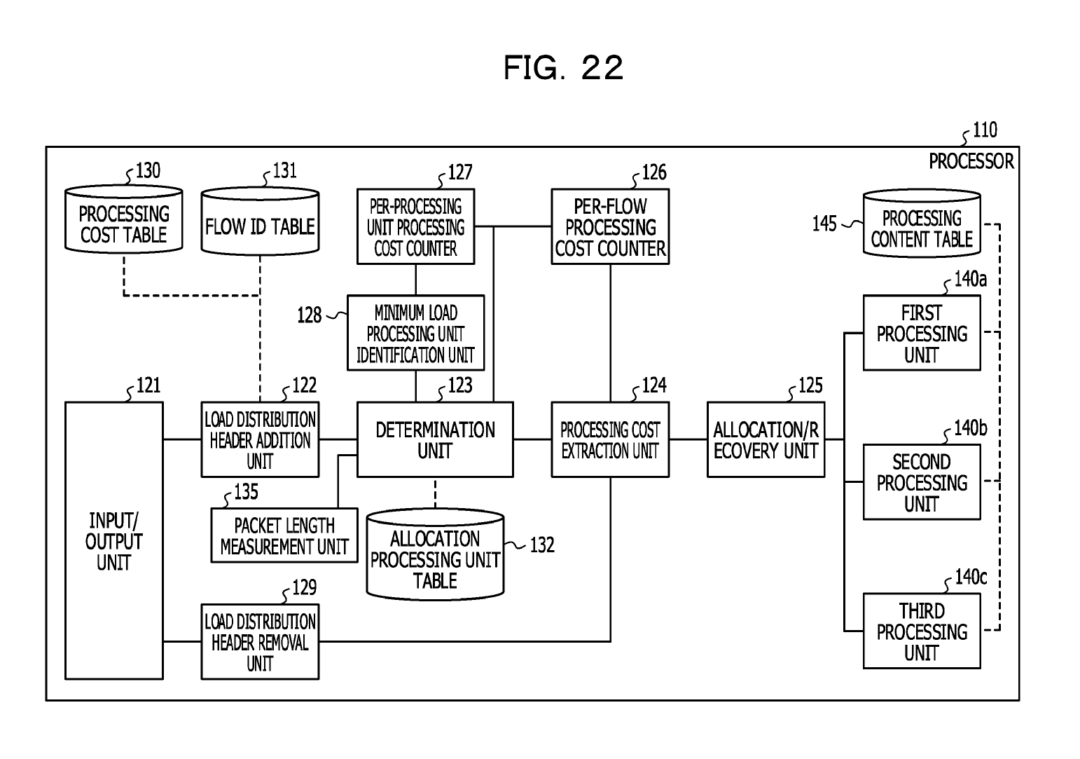

FIG. 22 is a diagram illustrating a function block of a processor 110 according to the fifth embodiment. The same reference numeral is assigned to the same function block as the function block illustrated in FIG. 13 of the first embodiment, and the description is omitted herein. When the processor 110 is a CPU, each of the function blocks illustrated in FIG. 22 is achieved by causing the processor 110 to execute a computer program that has been loaded to the volatile memory 170. The processor 110 functions as a packet length measurement unit 135 in addition to the functions illustrated in FIG. 13. The packet length measurement unit 135 measures the packet lengths of a plurality of packets to each of which the load distribution header has been added by the load distribution header addition unit 122, for each flow. In addition, in the case in which the proportion of short packets the packet lengths of which are certain values or less is a certain value or less, even when the per-flow processing cost total value of the flow ID becomes “0”, the determination unit 123 selects the same processing unit 140 as the processing unit 140 that is the allocation destination of a preceding packet, based on the packet lengths that have been measured by the packet length measurement unit 135. On the contrary, when the proportion of the short packets is larger than the certain value, the determination unit 123 changes the processing unit 140 that is an allocation destination at timing at which the per-flow processing cost total value of the flow ID becomes “0”, based on the packet lengths that have been measured by the packet length measurement unit 135. As a result, appropriate load distribution may be performed.

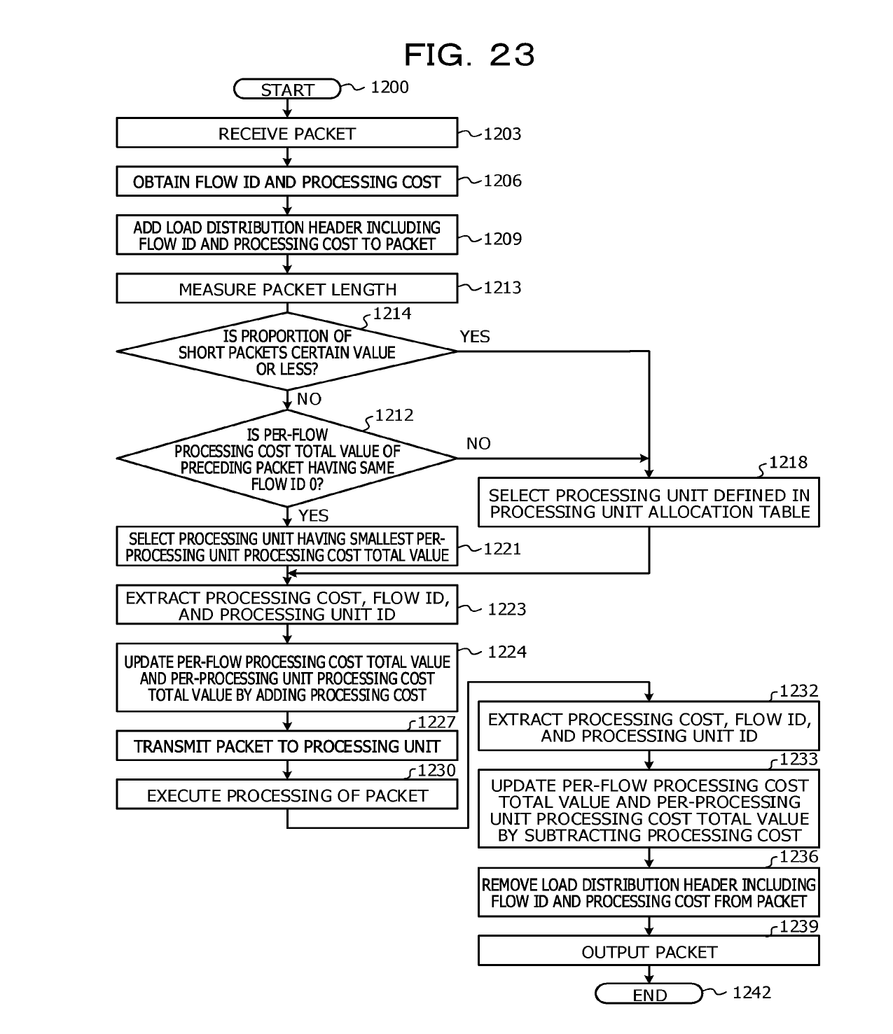

FIG. 23 is a flowchart of processing by the processor 110 according to the fifth embodiment. The same reference numeral is assigned to the same processing as the processing illustrated in FIG. 15 of the first embodiment, and the description is omitted herein. After processing 1209, in processing 1213, the packet length measurement unit 135 measures the packet lengths of the packets. Such measurement is performed for each flow. In processing 1214, the determination unit 123 determines whether the proportion of short packets is a certain value or less, based on the packet lengths that have been measured by the packet length measurement unit 135. In processing 1214, when it is determined that the proportion of the short packets is not the certain value or less, the processing proceeds to processing 1212. In addition, in processing 1214, when it is determined that the proportion of the short packets is the certain value or less, the processing proceeds to processing 1218, and a processing unit 140 is selected based on the allocation processing unit table 132.

In the fifth embodiment, as an example of a determination criterion for a short packet, for example, an example is conceived in which a packet of 256 Byte or less is determined to be a short packet when the range of the packet length of 64 Byte or more to 1500 Byte or less is defined by a specification.

### Sixth Embodiment

In a sixth embodiment, timing at which the processing unit 140 that is an allocation destination is changed is determined by counting the number of packets that have been processed at that time by the processing unit 140. For example, a counter is provided that increments the count value by 1 when a packet having a certain flow ID has been transmitted to a certain processing unit 140 and decrements the count value by 1 when a packet in which the processing has been completed has been recovered from the processing unit 140. In addition, when the counter value becomes “0”, it is determined that the processing unit 140 that is the allocation destination may be changed. The per-processing unit processing cost total value is measured similarly to the other embodiments, and is used when a processing unit 140 that is a new allocation destination is selected.

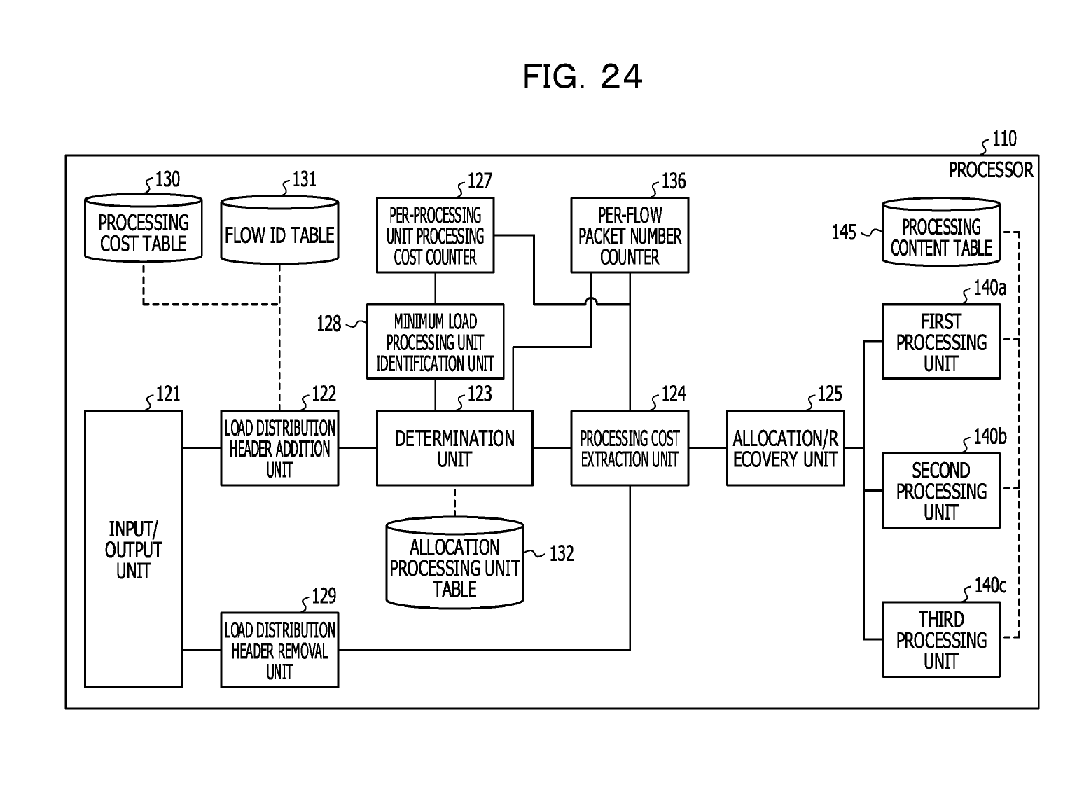

FIG. 24 is a diagram illustrating a function block of a processor 110 according to the sixth embodiment. The same reference numeral is assigned to the same function block as the function block illustrated in FIG. 13 of the first embodiment, and the description is omitted herein. When the processor 110 is a CPU, each of the function blocks illustrated in FIG. 24 is achieved by causing the processor 110 to execute a computer program that has been loaded to the volatile memory 170. The processor 110 functions as a per-flow packet number counter 136 in addition to the functions illustrated in FIG. 13. In the sixth embodiment, the per-flow processing cost counter 126 is not desired. Each time the processing cost extraction unit 124 transmits a packet to the processing unit 140 through the allocation/recovery unit 125, the per-flow packet number counter 136 increments the count value for each of the flows. In addition, each time the processing cost extraction unit 124 recovers a packet from the processing unit 140 through the allocation/recovery unit 125, the per-flow packet number counter 136 decrements the count value for each of the flows. In addition, when the count value of the per-flow packet number counter 136 becomes “0”, the determination unit 123 determines that the processing unit 140 that is the allocation destination may be changed.

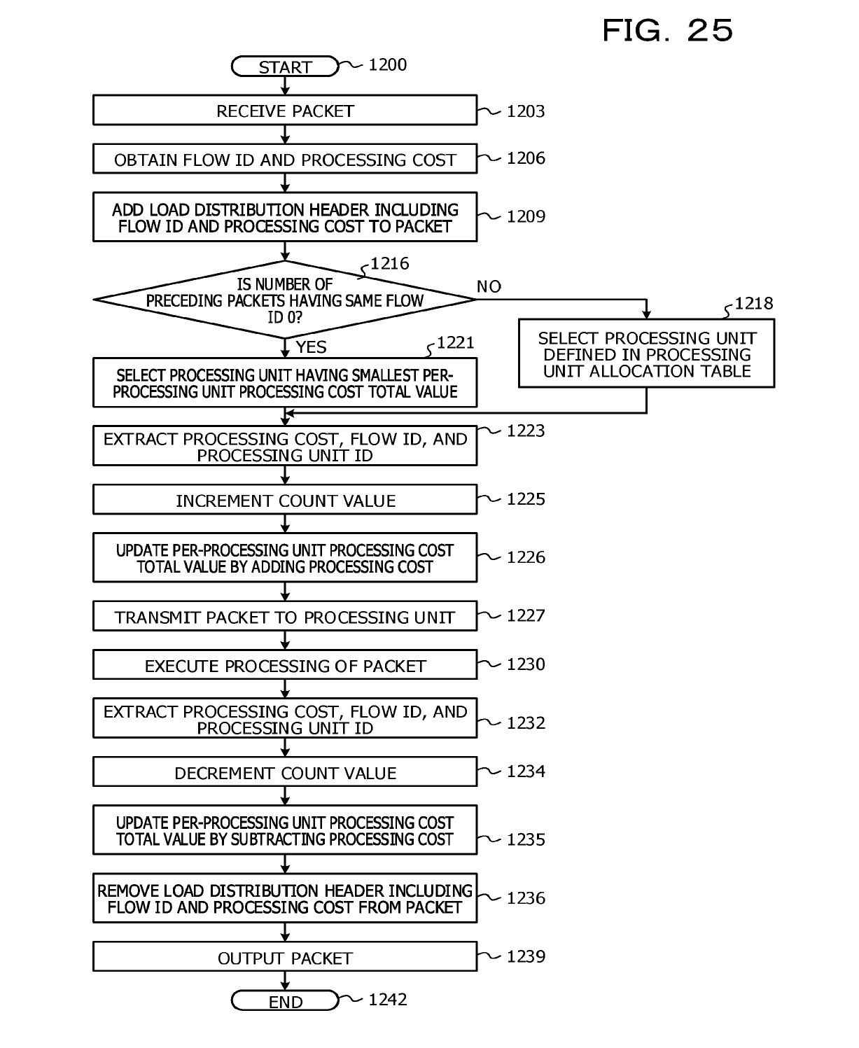

FIG. 25 is a flowchart of processing by the processor 110 according to the sixth embodiment. The same reference numeral is assigned to the same processing as the processing illustrated in FIG. 15 of the first embodiment, and the description is omitted herein. After processing 1209, in processing 1216, the determination unit 123 determines whether that the number of packets that are preceding packets having the same flow ID as the received packet and that are being processed in the processing unit 140 is “0”. The determination of the processing 1216 is performed based on the count value of the per-flow packet number counter 136. In processing 1216, when it has been determined that the number of packets is “0”, the processing proceeds to processing 1221, and when it has been determined that the number of packets is not “0”, the processing proceeds to processing 1218. In addition, after the processing 1223, in processing 1225, the per-flow packet number counter 136 increments the count value. In addition, after the processing 1232, in processing 1234, the per-flow packet number counter 136 decrements the count value.

### Seventh Embodiment

In a seventh embodiment, processing of packets is executed using a plurality of servers coupled to the relay device 100a instead of the plurality of processing units 140.

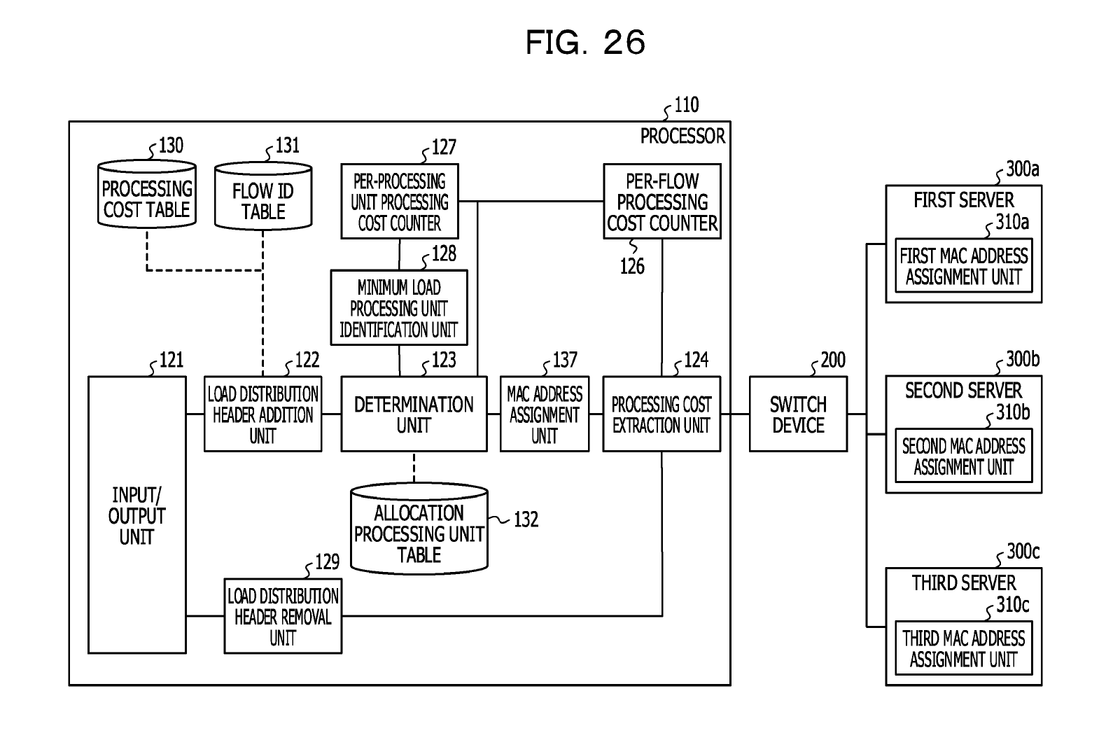

FIG. 26 is a diagram illustrating a function block of a processor 110 according to a seventh embodiment and a relationship between the processor 110, a switch device 200, a first server 300a, a second server 300b, and a third server 300c. Between the processor 110, the first server 300a, the second server 300b, and the third server 300c, transmission and reception of data are performed through the switch device 200. The switch device is, for example, a layer 2 switch. In order to perform transmission and reception of data through the switch device 200, the processor 110 also functions as a MAC address assignment unit 137, and the first server 300a, the second server 300b, and the third server 300c respectively include a first MAC address assignment unit 310a, a second MAC address assignment unit 310b, and a third MAC address assignment unit 310c.

As described above, in the embodiments, the load distribution between servers may also be applied in addition to the load distribution between the cores of the multi-core CPU and the load distribution between the plurality of CPU chips.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing system comprising:
a plurality of processing units configured to execute processing for a plurality of packets; and
a processor coupled to the plurality of processing units and configured to
transmit the plurality of packets to the plurality of processing units, and
receive, from the plurality of processing units, a plurality of packets including processing results processed by the plurality of processing units, wherein
the plurality of processing units are configured to execute processing for the plurality of packets transmitted from the processor based on processing content information used to identify a content of the processing to be executed for each of the plurality of packets, and
the processor is configured to
store, in a memory, processing cost information indicating a value of a processing cost of each of the plurality of packets, each of the processing cost information indicating a weight of a load to execute the processing for the corresponding packet and being defined in accordance with the content of the processing identified by the processing content information,
calculate a first processing cost total value for each of the plurality of processing units by
adding the value of the processing cost of each of the plurality of transmitted packets, based on the processing cost information stored in the memory each time the packet is transmitted to any one of the plurality of processing units, and
subtracting the value of the processing cost of each of the plurality of received packets, each time the packet is received from any one of the plurality of processing units,
select, from the plurality of processing units, a processing unit that is a transmission destination of a first packet, by comparing the first processing cost total values of the plurality of processing units with each other, and
transmit the first packet to the selected processing unit.

2. The data processing system according to claim 1, wherein
the processor is configured to
receive, from a network, a first sequence of packets which includes a plurality of packets belonging to an identical flow and includes the first packet and one or plurality of second packets which is transmitted to a first processing unit included in the plurality of processing units before the first packet is transmitted,
determine whether the processing in the first processing unit is completed for all of one or plurality of second packet transmitted to the first processing unit, and
select the first processing unit as the processing unit that is the transmission destination of the first packet when the processing in the first processing unit is determined to be not completed for all of the one or plurality of second packets.

3. The data processing system according to claim 2, wherein
the processor is configured to select a second processing unit having a small first processing cost total value as compared with the first processing cost total value of the first processing unit from among the plurality of processing units as the processing unit that is the transmission destination of the first packet, when the processing in the first processing unit is determined to be completed for all of the one or plurality of second packets.

4. The data processing system according to claim 2, wherein
the memory is configured to store the value of the processing cost for each of the flows,
the plurality of packets that belongs to the identical flow has an identical processing cost value, and
the plurality of packets that belongs to the identical flow corresponds to packets transmitted from an identical transmission source node to an identical destination node, or packets having an identical virtual local area network identification.

5. The data processing system according to claim 2, wherein
the processor is configured to
calculate a second processing cost total value for each of the flows by sequentially adding the value of the processing cost of each of the transmitted packets for each of the flows based on the processing cost information stored in the memory each time the packet is transmitted to any one of the plurality of processing units, and sequentially subtracting the value of the processing cost of each of the received packets for each of the flows each time the packet is received from any one of the plurality of processing units, and
determine that the processing in the first processing unit is completed for all of the one or plurality of second packets included in the first sequence of packets when the second processing cost total value for the identical flow to the first packet is 0.

6. The data processing system according to claim 2, wherein
the processor is configured to
identify the flow of the first packet based on a first header of the first packet,
obtain the value of the processing cost of the first packet by accessing the memory, and
add the value of the processing cost to the first header.

7. The data processing system according to claim 1, wherein
each of the plurality of processing units is configured to
generate a second packet having a second header to which the value of the processing cost of the first packet is set when the first packet is terminated or discarded, and
transmit the second packet to the processor, and
the processor is configured to
receive the second packet, and
subtract the value of the processing cost set to the second header of the second packet from the first processing cost total value.

8. The data processing system according to claim 1, wherein
the processor is configured to
record a time at which the first packet is transmitted to the first processing unit, and
subtract the value of the processing cost of the first packet from the first processing cost total value when the first packet is not received from the plurality of processing units within a certain time period from the transmission time.

9. The data processing system according to claim 2, wherein
the processor is configured to
measure a reception frequency of the plurality of packets included in the first sequence of packets, and
select the first processing unit as the transmission destination of the first packet when the reception frequency is a first certain value or more.

10. The data processing system according to claim 2, wherein
the processor is configured to
measure an average packet length of the plurality of packets included in the first sequence of packets, and
select the first processing unit as the transmission destination of the first packet when the average packet length is a second certain value or more.

11. The data processing system according to claim 1, wherein
the processing cost is a number of clocks of an operation clock of the processing unit, which is used for execution of the processing by the processing units for each of the plurality of packets.

12. A data processing method comprising:
transmitting, by a processor, a plurality of packets to a plurality of processing units which is configured to execute processing for the plurality of packets based on processing content information used to identify a content of the processing to be executed for each of the plurality of packets;
storing in a memory, by the processor, processing cost information indicating a value of a processing cost of each of the plurality of packets, each of the processing cost information indicating a weight of a load to execute the processing for the corresponding packet and being defined in accordance with the content of the processing identified by the processing content information;
receiving, by the processor, from the plurality of processing units, a plurality of packets including processing results processed by the plurality of processing units;
calculating, by the processor, a first processing cost total value for each of the plurality of processing units by
adding the value of the processing cost of each of the plurality of transmitted packets, based on the processing cost information stored in the memory each time the packet is transmitted to any one of the plurality of processing units, and
subtracting the value of the processing cost of each of the plurality of received packets, each time the packet is received from any one of the plurality of processing units;
selecting, by the processor, from the plurality of processing units, a processing unit that is a transmission destination of a first packet, by comparing the first processing cost total values of the plurality of processing units with each other; and
transmitting, by the processor, the first packet to the selected processing unit.

13. The method according to claim 12, further comprising:
receiving, by the processor, from a network, a first sequence of packets which includes a plurality of packets belonging to an identical flow and includes the first packet and one or plurality of second packets which is transmitted to a first processing unit included in the plurality of processing units before the first packet is transmitted;
determining, by the processor, whether the processing in the first processing unit is completed for all of one or plurality of second packet transmitted to the first processing unit; and
selecting, by the processor, the first processing unit as the processing unit that is the transmission destination of the first packet when the processing in the first processing unit is determined to be not completed for all of the one or plurality of second packets.

14. The method according to claim 13, further comprising:
selecting, by the processor, a second processing unit having a small first processing cost total value as compared with the first processing cost total value of the first processing unit from among the plurality of processing units as the processing unit that is the transmission destination of the first packet, when the processing in the first processing unit is determined to be completed for all of the one or plurality of second packets.

15. The method according to claim 13, further comprising:
calculating, by the processor, a second processing cost total value for each of the flows by sequentially adding the value of the processing cost of each of the transmitted packets for each of the flows based on the processing cost information stored in the memory each time the packet is transmitted to any one of the plurality of processing units, and sequentially subtracting the value of the processing cost of each of the received packets for each of the flows each time the packet is received from any one of the plurality of processing units; and
determining, by the processor, that the processing in the first processing unit is completed for all of the one or plurality of second packets included in the first sequence of packets when the second processing cost total value for the identical flow to the first packet is 0.

16. The method according to claim 13, further comprising:
identifying, by the processor, the flow of the first packet based on a first header of the first packet;
obtaining, by the processor, the value of the processing cost of the first packet by accessing the memory; and
adding, by the processor, the value of the processing cost to the first header.

17. The method according to claim 12, further comprising:
recording, by the processor, a time at which the first packet is transmitted to the first processing unit; and
subtracting, by the processor, the value of the processing cost of the first packet from the first processing cost total value when the first packet is not received from the plurality of processing units within a certain time period from the transmission time.

18. The method according to claim 13, further comprising:
measuring, by the processor, a reception frequency of the plurality of packets included in the first sequence of packets; and
selecting, by the processor, the first processing unit as the transmission destination of the first packet when the reception frequency is a first certain value or more.

19. The method according to claim 13, further comprising:
measuring, by the processor, an average packet length of the plurality of packets included in the first sequence of packets; and
selecting, by the processor, the first processing unit as the transmission destination of the first packet when the average packet length is a second certain value or more.

20. A non-transitory computer readable medium having stored therein a program that causes a computer to execute a process, the process comprising:
transmitting a plurality of packets to a plurality of processing units which is configured to execute processing for the plurality of packets based on processing content information used to identify a content of the processing to be executed for each of the plurality of packets;
storing, in a memory, processing cost information indicating a value of a processing cost of each of the plurality of packets, each of the processing cost information indicating a weight of a load to execute the processing for the corresponding packet and being defined in accordance with the content of the processing identified by the processing content information;
receiving, from the plurality of processing units, a plurality of packets including processing results processed by the plurality of processing units;
calculating a first processing cost total value for each of the plurality of processing units by
adding the value of the processing cost of each of the plurality of transmitted packets, based on the processing cost information stored in the memory each time the packet is transmitted to any one of the plurality of processing units, and
subtracting the value of the processing cost of each of the plurality of received packets, each time the packet is received from any one of the plurality of processing units;
selecting from the plurality of processing units, a processing unit that is a transmission destination of a first packet, by comparing the first processing cost total values of the plurality of processing units with each other; and
transmitting the first packet to the selected processing unit.
